(19) United States
(12) Patent Application Publication
(10) Pub. No.: US 2025/0367916 A9
(43) Pub. Date: Dec. 4, 2025

(54) BULK NANOCOMPOSITE MATERIALS AND METHODS FOR MAKING THESE

(71) Applicant: Massachusetts Institute of Technology, Cambridge, MA (US)

(72) Inventors: Brian L. Wardle, Lexington, MA (US); Luiz H. Acauan, Somerville, MA (US); Jingyao Dai, Cambridge, MA (US); Jeonyoon Lee, Cambridge, MA (US); Ashley Louise Kaiser, Cambridge, MA (US); Erick Gonzalez, Cambridge, MA (US); Chloe Curtis-Smith, Cambridge, MA (US); Xiaochen Li, Los Angeles, CA (US); Yuying Lin, Cambridge, MA (US)

(73) Assignee: Massachusetts Institute of Technology, Cambridge, MA (US)

(21) Appl. No.: 18/862,237

(22) PCT Filed: Mar. 3, 2023
(86) PCT No.: PCT/US2023/063728

§ 371 Date: Nov. 1, 2024

Related U.S. Application Data
(60) Provisional application No. 63/337,908, filed on May 3, 2022.
(60) Provisional application No. 63/337,902, filed on May 3, 2022.

(51) Int. Cl. B32B 27/20; B82Y 30/00

(52) U.S. Cl. CPC B32B 27/20; B82Y 30/00; B32B 2262/16

(57) ABSTRACT

Bulk nanocomposite materials comprising a solid support material and a plurality of elongated nanostructures distributed within the solid support material, and related systems and methods, are generally described. The elongated nanostructures occupy a volume fraction of at least 5 vol. %; less than or equal to 20 vol. % of the domain is occupied by voids having a volume of at least 10<7>micrometer<3>; the domain comprises a first dimension having a length of at least 1 centimeter; and the domain comprises a second dimension that is perpendicular to the first dimension, the second dimension having a length of at least 1 centimeter.

### RELATED APPLICATIONS

This application claims priority under 35 U.S.C. § 119(e) to U.S. Provisional Patent Application No. 63/337,908, filed May 3, 2022, and U.S. Provisional Patent Application No. 63/337,902, filed May 3, 2022, each of which are incorporated herein by reference in their entirety.

### GOVERNMENT SPONSORSHIP

This invention was made with government support under NNX17AJ32G awarded by NASA Goddard Space Flight Center and under W911NF-13-D-0001 awarded by the U.S. Army Research Office. The government has certain rights in the invention.

### TECHNICAL FIELD

Bulk nanocomposite materials and related systems and methods are generally described.

### BACKGROUND

The development of one-dimensional nanoscale systems, such as those based on aligned nanofibers, nanotubes, and nanowires, provide exciting opportunities for the design and fabrication of high-performance nanomaterials and devices. More specifically, the advantaged mass-specific thermal, electrical, and mechanical properties of nanostructures, such as carbon nanotubes, make these materials promising for next-generation composites and commercial applications in a variety of industries, especially with new nanoscale technologies leveraging multifunctionality.

Composite systems comprising such nanostructures, however, typically have low nanostructure concentrations, e.g., 1 volume percent (vol. %) or less.

### SUMMARY

Bulk nanocomposite materials and related systems and methods are generally described. The subject matter of the present invention involves, in some cases, interrelated products, alternative solutions to a particular problem, and/or a plurality of different uses of one or more systems and/or articles.

In certain aspects, articles are described.

In some embodiments, the article comprises a domain, comprising: a solid suppoapprt material; and a plurality of elongated nanostructures distributed within the solid support material; wherein: within the domain, the elongated nanostructures occupy a volume fraction of at least 5 vol. %; less than or equal to 20 vol. % of the domain is occupied by voids having a volume of at least 10⁷ μm³; the domain comprises a first dimension having a length of at least 1 centimeter; and the domain comprises a second dimension that is perpendicular to the first dimension, the second dimension having a length of at least 1 centimeter.

In certain embodiments, the article comprises a domain, comprising: a solid support material comprising a ceramic, carbon material, a metal, a metal oxide, a metalloid oxide, a metal nitride, a metalloid nitride, a metal carbide, a metalloid carbide, a metal silicate, a metalloid silicate, a metal halide, and/or a metalloid halide; and a plurality of elongated nanostructures distributed within the solid support material; wherein: within the domain, the elongated nanostructures occupy a volume fraction of at least 5 vol. %; less than or equal to 20 vol. % of the domain is occupied by voids having a volume of at least 10⁷ μm³; the domain comprises a first dimension having a length of at least 1 centimeter; and the domain comprises a second dimension that is perpendicular to the first dimension, the second dimension having a length of at least 1 centimeter.

In some embodiments, the article comprises a domain, comprising: a solid support material comprising a polymer; and a plurality of elongated nanostructures distributed within the solid support material; wherein: within the domain, the elongated nanostructures occupy a volume fraction of at least 5 vol. %; less than or equal to 1 vol. % of the domain is occupied by voids having a volume of at least 10⁷ μm³; the domain comprises a first dimension having a length of at least 1 centimeter; and the domain comprises a second dimension that is perpendicular to the first dimension, the second dimension having a length of at least 1 centimeter.

In some aspects, a method is provided.

In some embodiments, the method comprises arranging a plurality of elongated nanostructures within a support material and/or a support material precursor to form an arrangement of elongated nanostructures and support material and/or support material precursor; applying pressure to the arrangement to densify the nanostructures; and hardening the support material and/or the support material precursor to form a domain of elongated nanostructures within solid support material; wherein: within the domain, the elongated nanostructures occupy a volume fraction of at least 5 vol %; less than or equal to 20 vol. % of the domain is occupied by voids having a volume of at least 10⁷ μm³; the domain comprises a first dimension having a length of at least 1 centimeter; and the domain comprises a second dimension that is perpendicular to the first dimension, the second dimension having a length of at least 1 centimeter.

In certain embodiments, the method comprises arranging a plurality of elongated nanostructures within a support material and/or a support material precursor to form an arrangement of elongated nanostructures and support material and/or support material precursor; applying pressure to the arrangement to densify the nanostructures; and hardening the support material and/or the support material precursor to form a domain of elongated nanostructures within solid support material; wherein: the solid support material comprises a ceramic, a carbon material, a metal, a metal oxide, a metalloid oxide, a metal nitride, a metalloid nitride, a metal carbide, a metalloid carbide, a metal silicate, a metalloid silicate, a metal halide, and/or a metalloid halide; within the domain, the elongated nanostructures occupy a volume fraction of at least 5 vol. %; less than or equal to 20 vol. % of the domain is occupied by voids having a volume of at least 10⁷ μm³; the domain comprises a first dimension having a length of at least 1 centimeter; and the domain comprises a second dimension that is perpendicular to the first dimension, the second dimension having a length of at least 1 centimeter.

In some embodiments, the method comprises arranging a plurality of elongated nanostructures within a support material and/or a support material precursor to form an arrangement of elongated nanostructures and support material and/or support material precursor; applying pressure to the arrangement to densify the nanostructures; and hardening the support material and/or the support material precursor to form a domain of elongated nanostructures within solid support material; wherein: the solid support material comprises polymer; within the domain, the elongated nanostructures occupy a volume fraction of at least 5 vol. %; less than or equal to 1 vol. % of the domain is occupied by voids having a volume of at least 10⁷ μm³; the domain comprises a first dimension having a length of at least 1 centimeter; and the domain comprises a second dimension that is perpendicular to the first dimension, the second dimension having a length of at least 1 centimeter.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, according to certain embodiments, a schematic diagram of an article;

FIG. 1B shows, according to certain embodiments, a cross-sectional schematic diagram of a composite article;

FIG. 1C shows, according to certain embodiments, a cross-sectional schematic diagram of a composite article illustrating the concept of a three-dimensional convex hull;

FIG. 2A shows, according to certain embodiments, a plurality of elongated nanostructures arranged in an overlapping fashion;

FIG. 2B shows, according to certain embodiments, a plurality of elongated nanostructures arranged in a non-overlapping fashion;

FIG. 2C shows, according to certain embodiments, a plurality of elongated nanostructures arranged in an overlapping and non-overlapping fashion;

FIG. 2D shows, according to certain embodiments, a stacked configuration of a plurality of elongated nanostructures arranged in an overlapping and non-overlapping fashion;

FIG. 3A shows, according to certain embodiments, an article comprising a first domain and a second domain;

FIG. 3B shows, according to certain embodiments, a schematic diagram of an article comprising a stack of layers including a domain;

FIG. 3C shows, according to certain embodiments, a schematic side-view diagram of an article comprising a stack of layers including a domain;

FIG. 4A shows, according to certain embodiments, schematic diagrams of a composite article illustrating a method of arranging a plurality of elongated nanostructures within a support material and/or a support material precursor;

FIG. 4B shows, according to certain embodiments, a cross-sectional schematic diagram of a method of applying pressure to an arrangement of elongated nanostructures and substate;

FIG. 4C shows, according to certain embodiments, cross-sectional schematic diagrams of a composite article illustrating an alternative method of arranging a plurality of elongated nanostructures within a support material and/or a support material precursor;

FIG. 4D shows, according to certain embodiments, cross-sectional schematic diagrams of a composite article illustrating a method of applying pressure to an arrangement of elongated nanostructures and support material and/or support material precursor;

FIG. 4E shows, according to certain embodiments, a schematic diagram of a method of hardening a support material and/or a support material precursor;

FIG. 5A shows, according to certain embodiments, a schematic diagram of a high-tortuosity elongated nanostructure;

FIG. 5B shows, according to certain embodiments, a schematic diagram of a medium-tortuosity elongated nanostructure;

FIG. 5C shows, according to certain embodiments, a schematic diagram of a low-tortuosity elongated nanostructure;

FIG. 6 shows, according to certain embodiments, a schematic illustration representing a method of fabricating a polymer-containing composite lamina;

FIG. 7A shows, according to certain embodiments, a perspective image, an X-ray micro-computed tomography (micro-CT) image, and scanning electron microscopy (SEM) images of a 1-ply composite lamina;

FIG. 7B shows, according to certain embodiments, a perspective image, an X-ray micro-CT image, and SEM images of a 2-ply composite laminate;

FIG. 7C shows, according to certain embodiments, perspective images, an X-ray micro-CT image, SEM images, and an optical micrograph of an 8-ply composite laminate;

FIG. 8A shows, according to certain embodiments, a schematic illustration representing a method of fabricating a high carbon nanotube (CNT) volume fraction composite lamina;

FIG. 8B shows, according to some embodiments, perspective images and SEM images of a high CNT volume fraction composite lamina;

FIG. 9A shows, according to some embodiments, SEM images of a CNT/phenolic film before and after pyrolysis;

FIG. 9B shows, according to some embodiments, SEM images a boron nitride nanotube (BNNT)/phenolic film before and after pyrolysis;

FIG. 10A shows, according to certain embodiments, a schematic illustration representing a method of fabricating a silicon-oxycarbide composite lamina;

FIG. 10B shows, according to some embodiments, perspective images and SEM images of a silicon-oxycarbide composite lamina;

FIG. 11A shows, according to certain embodiments, a schematic illustration representing a method of fabricating a sodium silicate-containing composite lamina;

FIG. 11B shows, according to certain embodiments, SEM images of a sodium silicate-containing composite lamina;

FIGS. 12A-12C show, according to certain embodiments, perspective images depicting a method of fabricating a copper-containing composite lamina;

FIG. 13 shows, according to some embodiments, a cross-sectional SEM image of a CNT/copper composite lamina;

FIG. 14A shows, according to certain embodiments, a perspective image of a CNT/zinc oxide composite lamina;

FIG. 14B shows, according to certain embodiments, a cross-sectional SEM image of a CNT/zinc oxide composite lamina;

FIG. 15 shows, according to certain embodiments, X-ray diffraction spectra of a CNT/zinc oxide lamina; and

FIG. 16 shows, according to certain embodiments, a perspective image of a CNT/PMMA composite lamina.

### DETAILED DESCRIPTION

Bulk nanocomposite materials and related systems and methods are generally described. In some embodiments, the nanocomposite materials comprise a solid support material and a plurality of elongated nanostructures distributed within the support material. The bulk nanocomposite materials are, in accordance with certain embodiments, large scale in at least two dimensions and comprise a substantially high volume of elongated nanostructures and a substantially low volume of voids. The high volume of elongated nanostructures, low volume of voids, and large scale in at least two dimensions is achieved, according to certain embodiments, by maintaining alignment of the elongated nanostructures during fabrication of the bulk nanocomposite materials, which allows for a support material and/or support material precursor to flow through and spread between the elongated nanostructures via capillary action. In certain embodiments, the resulting article with elongated nanostructures distributed within a support material and/or support material precursor is then densified by the application of pressure and hardened, thereby providing the bulk nanocomposite materials.

It has been recognized, within the context of the present disclosure, that there is an unmet need and opportunity for innovation in the field of composite materials. Emerging high-performance applications and technologies, such as hypersonics and lightweighting, require the development of lightweight materials with enhanced thermal stability and shock resistance, therefore necessitating composites with high strength and fracture toughness at elevated temperatures. Conventional bulk composite materials (e.g., ceramics) have previously been engineered with nanostructures and display enhanced fracture toughness and ductile failure behavior, albeit with limitations in processing and scale, particularly both in nanostructure length and packing (e.g., vol. %).

Described herein are, according to certain embodiments, articles comprising a domain that includes a solid support material and a plurality of elongated nanostructures distributed within the support material. The solid support material and the plurality of elongated nanostructures may be configured within the domain such that the elongated nanostructures occupy a substantially high volume fraction (e.g., at least 5 vol. %) while the domain has a substantially low void volume (e.g., less than or equal to 1 vol. %). The elongated nanostructures are an advantageous high-temperature reinforcing material due to their scale, strength, and high thermal stability. An array of elongated nanostructures may be aligned and infused with the solid support material, followed by a densification process, resulting in a lightweight, strong, and nanostructure-reinforced matrix composite. Such composites may be, in accordance with certain embodiments, fabricated by a bulk nanocomposite laminating process.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

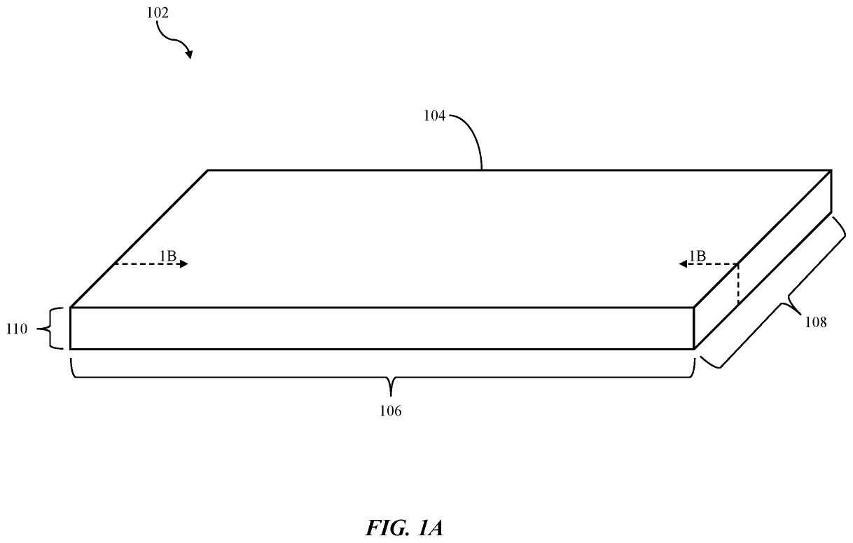

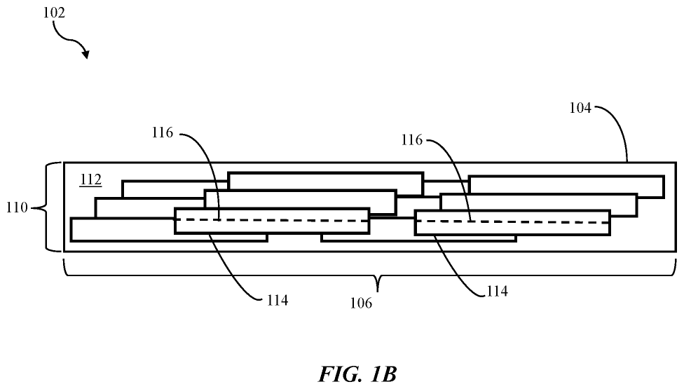

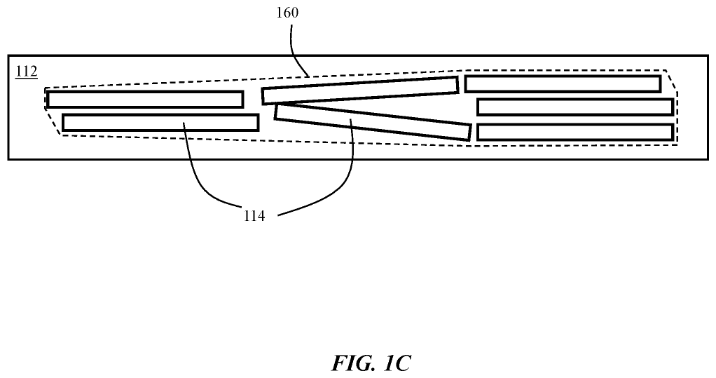

According to certain embodiments, an article is described. FIG. 1A shows, according to certain embodiments, a schematic diagram of article 102. In some embodiments, article 102 comprises domain 104. The “domain” of a given article, as the term is used in this application, is a geometric volume in which the nanostructures are contained. In some embodiments, the domain corresponds to the three-dimensional convex hull around a collection of nanostructures within the article. The phrase “three-dimensional convex hull” of a given collection of nanostructures is given its ordinary meaning in geometry and refers to the smallest three-dimensional convex set that contains all of the nanostructures within a given collection of nanostructures. The three-dimensional convex hull is also sometimes referred to in the field of geometry as the three-dimensional convex envelope or the three-dimensional convex closure, and it can be visualized (with respect to a collection of nanostructures) as the shape enclosed by a deformable sheet that is arranged such that it completely surrounds a three-dimensional depiction of the collection of nanostructures. FIG. 1C is a cross-sectional schematic illustration of a composite article, which can be used to illustrate the concept of a three-dimensional convex hull. In FIG. 1C, the cross-section of the three-dimensional convex hull of the collection of nanostructures 114 is shown as dotted line 160 surrounding nanostructures 114.

Referring to FIG. 1A, domain 104 may comprise any of a variety of suitable dimensions. In some embodiments, for example, domain 104 comprises first dimension 106, second dimension 108, and third dimension 110. According to certain embodiments, second dimension 108 is perpendicular to first dimension 106. In some embodiments, third dimension 110 is perpendicular to first dimension 106 and second dimension 108.

The length of first dimension 106 may be any of a variety of suitable lengths. In some embodiments, for example, first dimension 106 has a length of at least 1 centimeter, at least 2 centimeters, at least 5 centimeters, at least 10 centimeter, at least 15 centimeters, at least 20 centimeters, at least 50 centimeters, or more (e.g., at least 1 meter, at least 1 kilometer, etc.). In certain embodiments, first dimension 106 has a length of less than or equal to 100 centimeters, less than or equal to 50 centimeters, less than or equal to 20 centimeters, less than or equal to 15 centimeters, less than or equal to 10 centimeters, less than or equal to 5 centimeters, or less than or equal to 2 centimeters. Combinations of the above recited ranges are possible (e.g., first dimension 106 has a length between at least 1 centimeter and less than or equal to 100 centimeters, first dimension 106 has a length between at least 5 centimeters and less than or equal to 10 centimeters). Other ranges are also possible.

The length of second dimension 108 may be any of a variety of suitable lengths. In some embodiments, for example, second dimension 108 has a length of at least 1 centimeter, at least 2 centimeters, at least 5 centimeters, at least 10 centimeters, at least 15 centimeters, at least 20 centimeters, at least 50 centimeters, or more (e.g., at least 1 meter, at least 1 kilometer, etc.). In certain embodiments, second dimension 108 has a length of less than or equal to 100 centimeters, less than or equal to 50 centimeters, less than or equal to 20 centimeters, less than or equal to 15 centimeters, less than or equal to 10 centimeters, less than or equal to 5 centimeters, or less than or equal to 2 centimeters. Combinations of the above recited ranges are possible (e.g., second dimension 108 has a length between at least 1 centimeter and less than or equal to 100 centimeters, second dimension 108 has a length between at least 5 centimeters and less than or equal to 10 centimeters). Other ranges are also possible.

The length of third dimension 110 may be any of a variety of suitable lengths. In some embodiments, for example, third dimension 110 has a length of at least 0.01 micrometers, at least 0.1 micrometers, at least 0.2 micrometers, at least 0.5 micrometers, at least 1 micrometer, at least 2 micrometers, at least 5 micrometers, at least 10 micrometers, at least 20 micrometers, at least 50 micrometers, at least 100 micrometers, at least 500 micrometers, at least 1000 micrometers, or more. In some embodiments, third dimension 110 has a length less than or equal to 1 centimeter, less than or equal to 1000 micrometers, less than or equal to 500 micrometers, less than or equal to 100 micrometers, less than or equal to 50 micrometers, less than or equal to 20 micrometers, less than or equal to 10 micrometers, less than or equal to 5 micrometers, less than or equal to 2 micrometers, less than or equal to 1 micrometer, less than or equal to 0.5 micrometers, less than or equal to 0.2 micrometers, or less than or equal to 0.1 micrometers. Combinations of the above recited ranges are possible (e.g., third dimension 110 has a length between at least 0.01 micrometers and less than or equal to 1 centimeter, third dimension 110 has a length between at least 1 micrometer and less than or equal to 100 micrometers). Other ranges are also possible.

The domain may have any of a variety of suitable volumes. In certain embodiments, for example, the volume of the domain is greater than or equal to 10⁶ μm³, greater than or equal to 10⁸ m³, greater than or equal to 10¹⁰ m³, greater than or equal to 1 cm³, greater than or equal to 100 cm³, or greater (e.g., greater than or equal to 10,000 cm³, greater than or equal to 1 m³, etc.). In some embodiments, the volume of the domain is less than or equal to 10 m³, less than or equal to 1 m³, less than or equal to 10,000 cm³, less than or equal to 100 cm³, less than or equal to 1 cm³, less than or equal to 10¹⁰ m³, or less than or equal to 10⁸ m³. Combinations of the above recited ranged are possible (e.g., the volume of the domain is greater than or equal to 10⁶ m³ and less than or equal to 10 m³, the volume of the domain is greater than or equal to 1 cm³ and less than or equal to 100 cm³). Other ranges are also possible.

FIG. 1B shows, according to certain embodiments, a cross-sectional schematic diagram of article 102, wherein the cross-section is taken along lines 1B shown in FIG. 1A. Referring to FIG. 1B, domain 104 comprises solid support material 112, according to some embodiments. Any of a variety of suitable solid support materials 112 may be envisioned, as explained herein in greater detail.

In some embodiments, for example, solid support material 112 comprises a polymer. Examples of suitable classes of polymers include, but are not limited to, thermoplastic polymers and thermoset polymers. In some embodiments, the polymer comprises an epoxy, a polybismaleimide (BMI), a poly(methyl methacrylate) (PMMA), a polyaryletherketone (PAEK), and/or a polyurethane. In certain embodiments, the polymer comprises polyether ether ketone (PEEK), polyetherketoneketone (PEKK), and/or polyimide. In some embodiments, the polymer is an organic polymer (i.e., a polymer comprising carbon in the backbone of the polymer). Other polymers are also possible, as the disclosure is not meant to be limiting in this regard.

In certain embodiments, solid support material 112 comprises a metal. As used in the context of the solid support material, the term “metal” refers to elemental metal and/or alloys in metallic form, i.e., having an oxidation state of zero. Examples of suitable metals include, but are not limited to, copper (Cu), aluminum (Al), titanium (Ti), and/or iron (Fe). In certain embodiments, the solid support material comprises steel. Other metals are also possible, as the disclosure is not meant to be limiting in this regard.

According to some embodiments, solid support material 112 comprises a ceramic, a carbon material, a metal oxide, a metalloid oxide, a metal nitride, a metalloid nitride, a metal carbide, a metalloid carbide, a metal silicate, a metalloid silicate, a metal halide (e.g., a metal chloride), and/or a metalloid halide (e.g., a metalloid chloride). In certain embodiments, for example, the solid support material comprises silicon carbide (SiC), pyrolytic carbon (PyC), silicon oxycarbide, sodium silicate, zinc oxide (ZnO), and/or sodium chloride. The solid support material comprises a ceramic in some embodiments. Other ceramics, metal oxides, metalloid oxides, metal nitrides, metalloid nitrides, metal carbides, metalloid carbides, metal silicates, metalloid silicates, metal halides, and/or metalloid halides are also possible, as the disclosure is not meant to be limiting in this regard.

In some embodiments, a relatively high percentage of the support material is made up of polymer. For example, in some embodiments, at least 50 weight percent (wt %), at least 75 wt %, at least 90 wt %, at least 95 wt %, at least 99 wt %, or more (e.g., 100 wt %) of the support material is made of polymer.

In some embodiments, a relatively high percentage of the support material is made up of metal. For example, in some embodiments, at least 50 wt %, at least 75 wt %, at least 90 wt %, at least 95 wt %, at least 99 wt %, or more (e.g., 100 wt %) of the support material is made of metal.

In some embodiments, a relatively high percentage of the support material is made up of a ceramic, a carbon material, a metal oxide, a metalloid oxide, a metal nitride, a metalloid nitride, a metal carbide, a metalloid carbide, a metal silicate, a metalloid silicate, a metal halide, and/or a metalloid halide. For example, in some embodiments, at least 50 wt %, at least 75 wt %, at least 90 wt %, at least 95 wt %, at least 99 wt %, or more (e.g., 100 wt %) of the support material is made of ceramic. In some embodiments, at least 50 wt %, at least 75 wt %, at least 90 wt %, at least 95 wt %, at least 99 wt %, or more (e.g., 100 wt %) of the support material is made of a carbon material, a metal, a metal oxide, a metalloid oxide, a metal nitride, a metalloid nitride, a metal carbide, a metalloid carbide, a metal silicate, a metalloid silicate, a metal halide, and/or a metalloid halide.

According to some embodiments, domain 104 comprises a plurality of elongated nanostructures 114. As used herein, the term “elongated nanostructure” refers to a structure having a maximum cross-sectional diameter of less than or equal to 1 micrometer and a length resulting in an aspect ratio greater than or equal to 10. In some embodiments, the elongated nanostructure can have an aspect ratio greater than or equal to 100, greater than or equal to 1000, greater than or equal to 10,000, or greater. Those skilled in the art would understand that the aspect ratio of a given structure is measured along the longitudinal axis of the elongated nanostructure, and is expressed as the ratio of the length of the longitudinal axis of the nanostructure to the maximum cross-sectional diameter of the nanostructure. The “longitudinal axis” of an article corresponds to the imaginary line that connects the geometric centers of the cross-sections of the article as a pathway is traced, along the longest length of the article, from one end to another. See, for example, longitudinal axis 116 of nanostructures 114 in FIG. 1B.

In some cases, the elongated nanostructure may have a maximum cross-sectional diameter of less than or equal to 1 micrometer, less than or equal to 100 nanometers, less than or equal to 50 nanometers, less than or equal to 25 nanometers, less than or equal to 10 nanometers, or, in some cases, less than or equal to 1 nanometer. A “maximum cross-sectional diameter” of an elongated nanostructure, as used herein, refers to the largest dimension between two points on opposed outer boundaries of the elongated nanostructure, as measured perpendicular to the length of the elongated nanostructure (e.g., the length of a carbon nanotube). The “average of the maximum cross-sectional diameters” of a plurality of structures refers to the number average.

In certain embodiments, the elongated nanostructures described herein have relatively low geometric tortuosities. For example, in certain embodiments, at least a portion (e.g., at least 10%, at least 25%, at least 50%, at least 75%, at least 90%, at least 95%, at least 99%, or all) of the elongated nanostructures have geometric tortuosities of less than or equal to 3, less than or equal to 2.5, less than or equal to 2, less than or equal to 1.5, less than or equal to 1.2, or less than or equal to 1.1 (and, in certain embodiments, down to substantially 1).

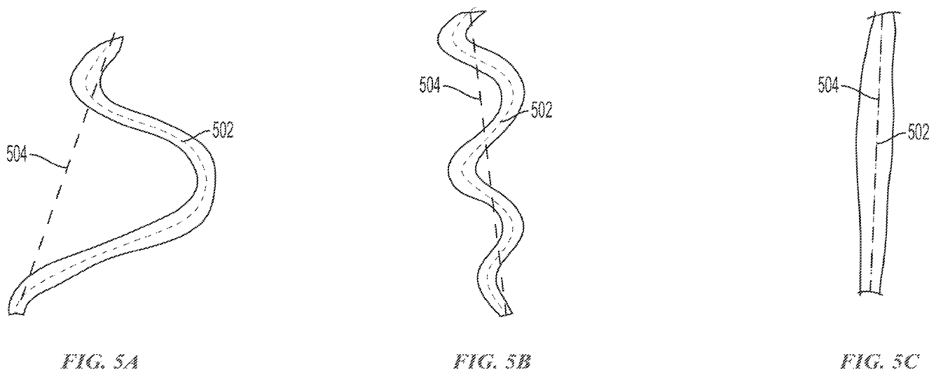

The geometric tortuosity of a particular elongated nanostructure is calculated as the effective path length divided by the projected path length. Examples are shown in FIGS. 5A-5C. FIG. 5A shows an example of a high-tortuosity elongated nanostructure, where the geometric tortuosity is calculated by dividing the length of longitudinal axis 502 by projected path length 504. FIG. 5B shows an example of a medium-tortuosity elongated nanostructure, and FIG. 5C shows an example of a low-tortuosity elongated nanostructure. One of ordinary skill in the art would be capable of determining the geometric tortuosity of a given elongated nanostructure by examining an image (e.g., a magnified image such as a scanning electron micrograph, a microscope enhanced photograph, or an unmagnified photograph), determining the effective path length by tracing a pathway from one end of the elongated nanostructure to the other end of the elongated nanostructure along the longitudinal axis of the elongated nanostructure, and determining the projected path length by measuring the straight-line distance between the ends of the elongated nanostructure.

According to certain embodiments, the plurality of elongated nanostructures has an average geometric tortuosity of less than or equal to 3, less than or equal to 2.5, less than or equal to 2, less than or equal to 1.5, less than or equal to 1.2, or less than or equal to 1.1 (and, in certain embodiments, down to substantially 1). The average geometric tortuosity of a plurality of elongated nanostructures is calculated as the number average of the geometric tortuosities of the individual elongated nanostructures.

In some embodiments, the elongated nanostructures within the plurality of elongated nanostructures may be closely spaced. For example, the number average of the nearest neighbor distances of the elongated nanostructures within the plurality of elongated nanostructures may be less than or equal to 250 nm, less than or equal to 200 nm, less than or equal to 100 nm, less than or equal to 80 nm, less than or equal to 60 nm, less than or equal to 40 nm, less than or equal to 30 nm, less than or equal to 20 nm, less than or equal to 10 nm, less than or equal to 5 nm, or less. In certain embodiments, the number average of the nearest neighbor distances of the elongated nanostructures within the plurality of elongated nanostructures may be at least 1 nm, at least 5 nm, at least 10 nm, at least 20 nm, at least 30 nm, at least 40 nm, at least 60 nm, at least 80 nm, at least 100 nm, or at least 200 nm. Combinations of the above-referenced ranges are also possible (e.g., at least 1 nm and less than or equal to 250 nm). Other ranges are also possible.

The elongated nanostructure can have a cylindrical or pseudo-cylindrical shape, in some embodiments. In some embodiments, the elongated nanostructure can be a nanotube, such as a carbon nanotube (CNT) and/or a boron nitride nanotube (BNNT). Other examples of elongated nanostructures include, but are not limited to, nanofibers and nanowires.

Elongated nanostructures can be single molecules (e.g., in the case of some nanotubes) or can include multiple molecules bound to each other (e.g., in the case of some nanofibers).

As used herein, the term “nanotube” refers to a substantially cylindrical elongated nanostructure comprising a fused network of primarily six-membered rings (e.g., six-membered aromatic rings). Nanotubes may include, in some embodiments, a fused network of at least 10, at least 100, at least 1000, at least 10⁵, at least 10⁶, at least 10⁷, or at least 10⁸ rings (e.g., six-membered rings such as six-membered aromatic rings), or more. In some cases, nanotubes may resemble a sheet of graphite formed into a seamless cylindrical structure. It should be understood that the nanotube may also comprise rings or lattice structures other than six-membered rings. According to certain embodiments, at least one end of the nanotube may be capped, i.e., with a curved or nonplanar aromatic group.

Elongated nanostructures may be formed of a variety of materials, in some embodiments. In certain embodiments, the elongated nanostructures comprise carbon (e.g., carbon-based nanostructures) or boron nitride (e.g., boron nitride nanostructures). Other non-limiting examples of materials from which elongated nanostructures may be formed include silicon, alumina, indium-gallium-arsenide materials, silicon nitride (e.g., Si₃N₄), silicon carbide, dichalcogenides (WS₂), oxides (e.g., titanium dioxide, molybdenum trioxide), and boron-carbon-nitrogen compounds (e.g., BC₂N₂, BC₄N). In some embodiments, the elongated nanostructure may be formed of one or more inorganic materials. Non-limiting examples include semiconductor nanowires such as silicon (Si) nanowires, indium-gallium-arsenide (InGaAs) nanowires, and nanotubes comprising boron nitride (BN), silicon nitride (Si₃N₄), silicon carbide (SiC), dichalcogenides such as (WS₂), oxides such as titanium dioxide (TiO₂) and molybdenum trioxide (MoO₃), and boron-carbon-nitrogen compositions such as BC₂N₂ and BC₄N.

In certain embodiments, the plurality of elongated nanostructures 114 are distributed within solid support material 112. One example of such a distribution is shown, for example, in FIG. 1B.

The plurality of elongated nanostructures 114 may be distributed within solid support material 112 in any of a variety of suitable configurations. In some embodiments, for example, longitudinal axes 116 of elongated nanostructures 114 are substantially aligned with each other. Those skilled in the art would understand that elongated nanostructures may have some inherent deviation along their length such as waviness. Accordingly, for the purposes of determining the alignment of elongated nanostructures with each other, one would draw a line from one end of the elongated nanostructure to the other end of the elongated nanostructure, such as line 504 shown in FIG. 5A. Alignment of the elongated nanostructures with each other can be determined by 3-dimensional electron tomography.

In some embodiments, at least 50%, at least 75%, at least 90%, at least 95%, at least 99%, or all of the elongated nanostructures within the forest are within 30 degrees, within 20 degrees, within 10 degrees, within 5 degrees, or within 2 degrees of parallel to at least 50%, at least 75%, at least 90%, at least 95%, at least 99%, or all of the other elongated nanostructures within the forest.

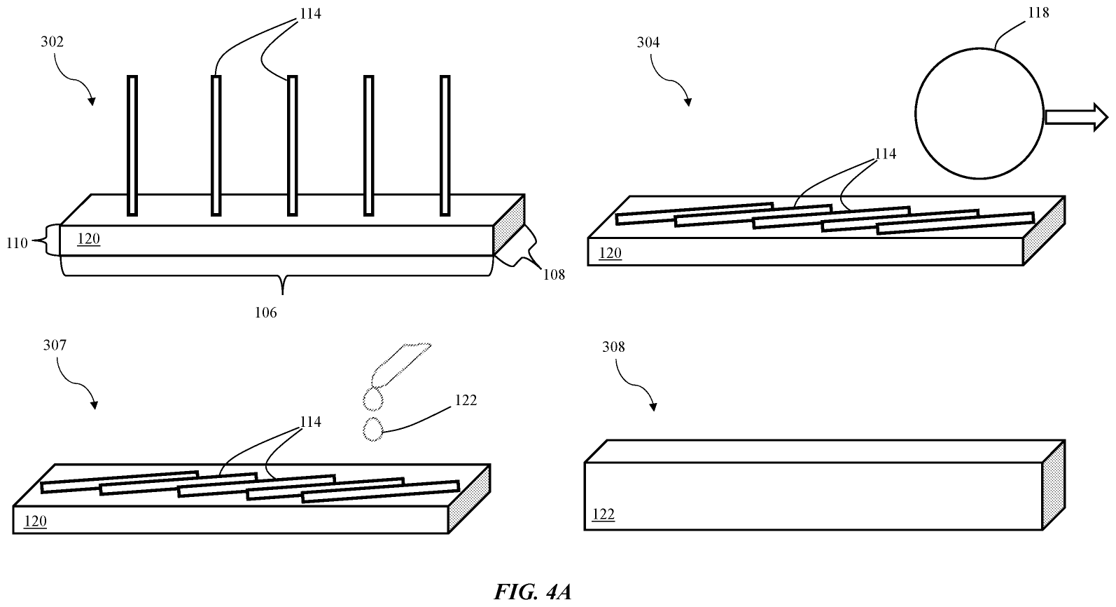

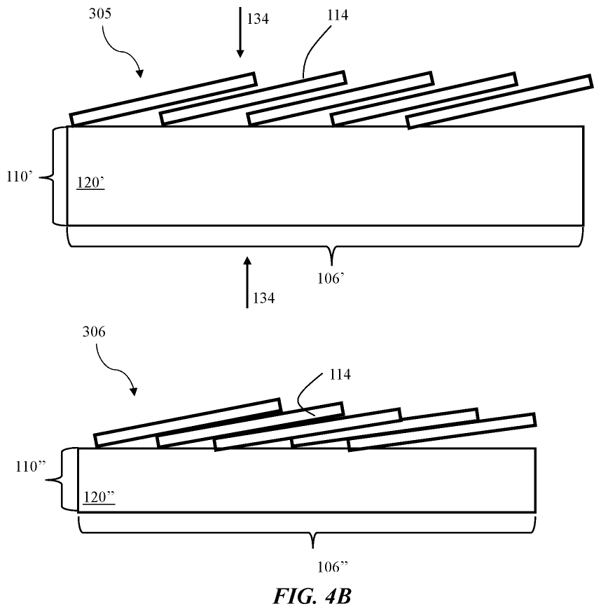

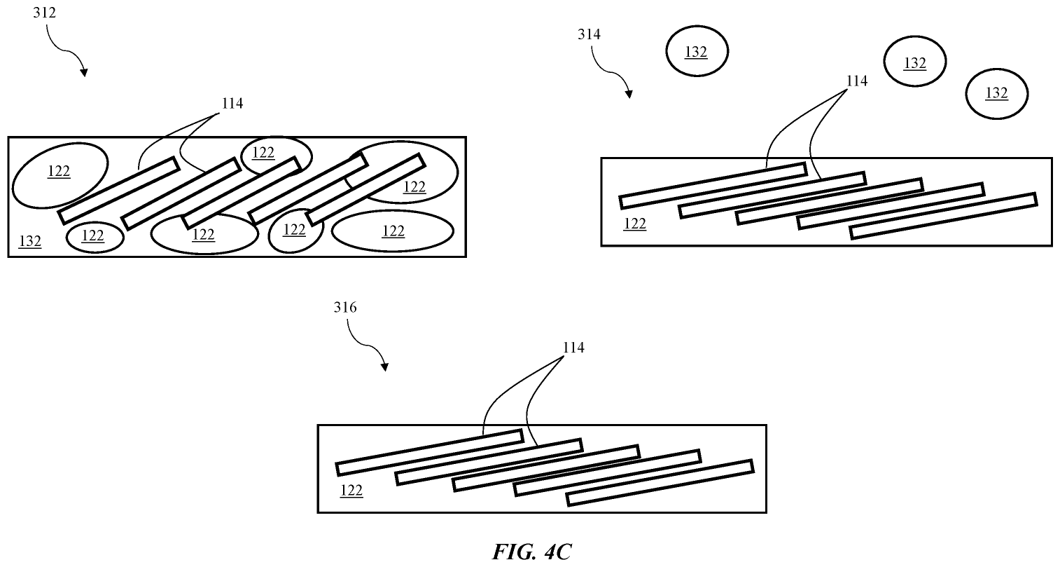

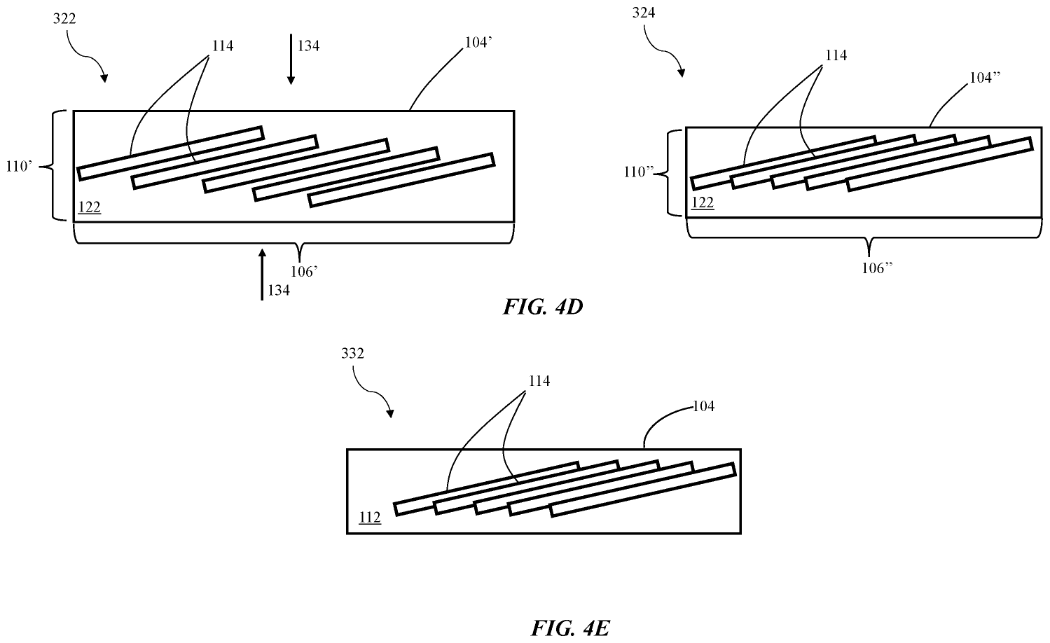

In some embodiments, at least 50%, at least 60%, at least 70%, at least 80%, at least 90%, at least 95%, at least 99%, or all of the elongated nanostructures are parallel to within 30 degrees, within 20 degrees, within 10 degrees, within 5 degrees, or within 2 degrees of a common vector. One example is shown in FIG. 1B, where longitudinal axes 116 are all horizontally arranged. Another example is shown in the upper right-hand portion of FIG. 4A, in which nanostructures 114 remain aligned with a common vector (and with each other) after they have been knocked over but prior to penetration by support material and/or support material precursor 122. As noted above, those skilled in the art would understand that elongated nanostructures may have some inherent deviation along their length such as waviness. Accordingly, for the purposes of determining the alignment of elongated nanostructures with respect to a common vector, one would draw a line from one end of the elongated nanostructure to the other end of the elongated nanostructure, such as line 504 shown in FIG. 5A. Alignment of the elongated nanostructures with a common vector can be determined by 3-dimensional electron tomography. As noted above, the high volume of elongated nanostructures, low volume of voids, and large scale in at least two dimensions in the final composite can be achieved, in accordance with certain embodiments, by maintaining alignment of the elongated nanostructures during fabrication of the bulk nanocomposite materials, which allows for a support material and/or a support material precursor to flow through and spread between the elongated nanostructures via capillary action.

According to certain embodiments, first dimension 106 of domain 104 is substantially parallel to (i.e., within 30 degrees, within 20 degrees, within 10 degrees, within 5 degrees, within 2 degrees, or within 1 degree of parallel to) longitudinal axes 116 of elongated nanostructures 114.

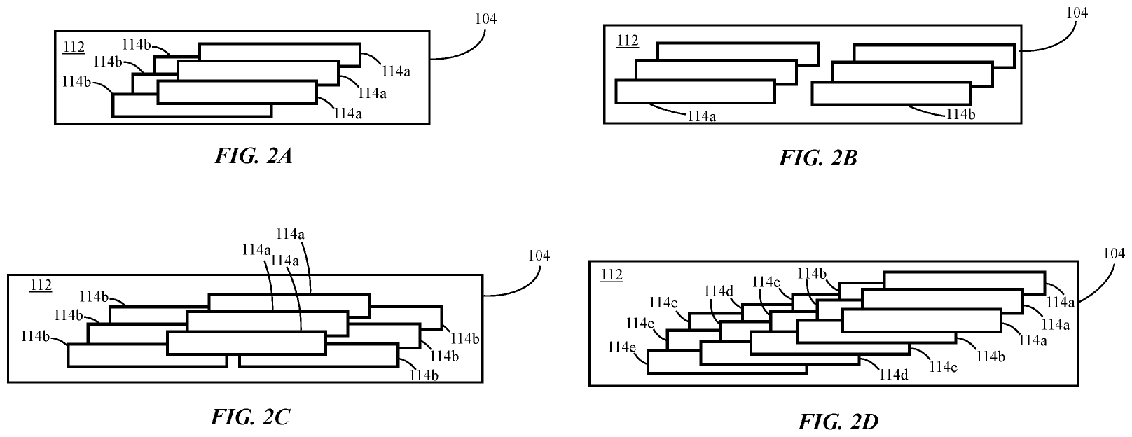

FIG. 2A shows, according to certain embodiments, a plurality of elongated nanostructures arranged in an overlapping fashion. In some embodiments, for example, at least a portion of the plurality of elongated nanostructures are arranged in solid support material 112 such that first portion of elongated nanostructures 114a at least partially overlaps second portion of elongated nanostructures 114b.

FIG. 2B shows, according to certain embodiments, a plurality of nanostructures arranged in a non-overlapping fashion. In some embodiments, for example, first portion of elongated nanostructures 114a and second portion of elongated nanostructures 114b are arranged in support material 112 in a non-overlapping fashion. In some embodiments, the plurality of elongated nanostructures arranged in a non-overlapping fashion may be arranged in an end-to-end fashion, as shown in FIG. 2B.

FIG. 2C shows, according to certain embodiments, a plurality of nanostructures arranged in an overlapping and non-overlapping fashion. In some embodiments, at least a portion of the plurality of elongated nanostructures are arranged in solid support material 112 such that first portion of elongated nanostructures 114a at least partially overlaps second portion of elongated nanostructures 114b and at least a portion of the plurality of elongated nanostructures 114b are arranged in a non-overlapping (e.g., end-to-end) fashion.

FIG. 2D shows, according to certain embodiments, a stacked configuration of a plurality of nanostructures arranged in an overlapping and non-overlapping fashion. In some embodiments, the configuration of elongated nanostructures shown in FIG. 2A may extend such that at a least portion of the plurality of elongated nanostructures are arranged in an overlapping and non-overlapping fashion. In some embodiments, for example, at least a portion of the plurality of elongated nanostructures are arranged in solid support material 112 such that first portion of elongated nanostructures 114a at least partially overlaps second portion of elongated nanostructures 114b, which at least partially overlap third portion of elongated nanostructures 114c, which at least partially overlaps fourth portion of elongated nanostructures 114d, which at least partially overlaps fifth portion of elongated nanostructures 114e. In certain embodiments, first portion of elongated nanostructures 114a are arranged in a non-overlapping fashion with fifth portion of elongated nanostructures 114e. Although five portions of elongated nanostructures are shown in FIG. 2D, more portions (e.g., six portions, eight portions, ten portions) or less portions (e.g., four portions, three portions) may be arranged in a stacked configuration in an overlapping and non-overlapping fashion, as the disclosure is not meant to be limiting in this regard.

The elongated nanostructures may occupy any of a variety of suitable volume fractions within the domain. In certain embodiments, for example, the elongated nanostructures occupy a volume fraction of at least 5 vol. %, at least 10 vol. %, at least 15 vol. %, at least 20 vol. %, at least 25 vol. %, at least 30 vol. %, at least 35 vol. %, at least 40 vol. %, at least 45 vol. %, at least 50 vol. %, at least 55 vol. %, at least 60 vol. %, at least 65 vol. %, at least 70 vol. %, at least 75 vol. %, or more within the domain. According to some embodiments, the elongated nanostructures occupy a volume fraction less than or equal to less than or equal to 78 vol. %, less than or equal to 75 vol. %, less than or equal to 70 vol. %, less than or equal to 65 vol. %, less than or equal to 60 vol. %, less than or equal to 55 vol. %, less than or equal to 50 vol. %, less than or equal to 45 vol. %, less than or equal to 40 vol. %, less than or equal to 35 vol. %, less than or equal to 30 vol. %, less than or equal to 25 vol. %, less than or equal to 20 vol. %, less than or equal to 15 vol. %, or less than or equal to 10 vol. % within the domain. Combinations of the above recited ranges are possible (e.g., the elongated nanostructures occupy a volume fraction between at least 5 vol. % and less than or equal to 78 vol. % within the domain, the elongated nanostructures occupy a volume fraction between at least 30 vol. % and less than or equal to 50 vol. % within the domain). Other ranges are also possible.

The domain may comprise any of a variety of suitable amounts of the elongated nanostructures. In some embodiments, for example, the domain comprises greater than or equal to 1,000 elongated nanostructures, greater than or equal to 2,000 elongated nanostructures, greater than or equal to 5,000 elongated nanostructures, greater than or equal to 10,000 elongated nanostructures, greater than or equal to 20,000 elongated nanostructures, greater than or equal to 50,000 elongated nanostructures, greater than or equal to 100,000 elongated nanostructures, or greater than or equal to 200,000 elongated nanostructures. In certain embodiments, the domain comprises less than or equal to 500,000 elongated nanostructures, less than or equal to 200,000 elongated nanostructures, less than or equal to 100,000 elongated nanostructures, less than or equal to 50,000 elongated nanostructures, less than or equal to 20,000 elongated nanostructures, less than or equal to 10,000 elongated nanostructures, less than or equal to 5,000 elongated nanostructures, or less than or equal to 2,000 elongated nanostructures. Combinations of the above recited ranges are possible (e.g., the domain comprises between greater than or equal to 1,000 elongated nanostructures and less than or equal to 500,000 elongated nanostructures, the domain comprises between greater than or equal to 50,000 and less than or equal to 200,000 elongated nanostructures). Other ranges are also possible.

According to certain embodiments, the domain comprising the solid support material and the plurality of elongated nanostructures may advantageously have a low void volume. As used herein, the term “void volume” generally refers to the total volume within a domain that is enclosed (as opposed to an open volume, such as a cavity or open cell that is exposed to the environment outside the solid article containing the domain), that lies outside the elongated nanostructures, and that is occupied by gas or a vacuum. The void volume of a particular domain may be measured using X-ray computed tomography (CT) imaging.

In some embodiments, a relatively small percentage of the volume of the domain is occupied by voids having a substantial size. The reduction or elimination of voids having substantial size was a surprising benefit of certain of the processing methods described herein and has led to composite materials that exhibit enhanced mechanical robustness. In certain embodiments, for example, less than or equal to 20 vol. % (or less than or equal to 10 vol. %, less than or equal to 5 vol. %, less than or equal to 2 vol. %, less than or equal to 1 vol. %, less than or equal to 0.5 vol. %, less than or equal to 0.1 vol. %, less than or equal to 0.05 vol. %, less than or equal to 0.01 vol. %, or less) of the domain is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 μm³). As would be understood by those of ordinary skill in the art, the percentage of a domain (or other region) that is occupied by voids having a volume within a size range is determined by adding together the volumes of all voids having a size within that range and dividing that result by the total volume of the domain (or other region). For example, to figure out the percentage of a domain occupied by voids having a volume of at least 100 μm³, one would locate all voids having a volume of at least 100 μm³ within the domain, add together the volumes of the voids having a volume of at least 100 μm³ within the domain to determine the cumulative volume of all voids over 100 μm³, divide the cumulative volume of the voids by the total volume of the domain, and multiply the result by 100%.

According to some embodiments, less than or equal to 20 vol. % (or less than or equal to 10 vol. %, less than or equal to 5 vol. %, less than or equal to 2 vol. %, less than or equal to 1 vol. %, less than or equal to 0.5 vol. %, less than or equal to 0.1 vol. %, less than or equal to 0.05 vol. %, less than or equal to 0.01 vol. %, or less) of the region within the outer boundaries of the solid support material is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 m³).

In some non-limiting embodiments in which the solid support material comprises a polymer, less than or equal to 20 vol. % (or less than or equal to 10 vol. %, less than or equal to 5 vol. %, less than or equal to 2 vol. %, less than or equal to 1 vol. %, less than or equal to 0.5 vol. %, less than or equal to 0.1 vol. %, less than or equal to 0.05 vol. %, less than or equal to 0.01 vol. %, or less) of the domain is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 m³). In some non-limiting embodiments in which the solid support material comprises a polymer, less than or equal to 1 vol. % (or less than or equal to 0.5 vol. %, less than or equal to 0.1 vol. %, less than or equal to 0.05 vol. %, less than or equal to 0.01 vol. %, or less) of the domain is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 m³).

In some non-limiting embodiments in which the solid support material comprises a polymer, less than or equal to 20 vol. % (or less than or equal to 10 vol. %, less than or equal to 5 vol. %, less than or equal to 2 vol. %, less than or equal to 1 vol. %, less than or equal to 0.5 vol. %, less than or equal to 0.1 vol. %, less than or equal to 0.05 vol. %, less than or equal to 0.01 vol. %, or less) of the region within the outer boundaries of the solid support material is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 μm³). In some non-limiting embodiments in which the solid support material comprises a polymer, less than or equal to 1 vol. % (or less than or equal to 0.5 vol. %, less than or equal to 0.1 vol. %, less than or equal to 0.05 vol. %, less than or equal to 0.01 vol. %, or less) of the region within the outer boundaries of the solid support material is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 μm³).

In some non-limiting embodiments in which the solid support material comprises a metal, less than or equal to 20 vol. % (or less than or equal to 10 vol. %, less than or equal to 5 vol. %, less than or equal to 2 vol. %, less than or equal to 1 vol. %, less than or equal to 0.5 vol. %, less than or equal to 0.1 vol. %, less than or equal to 0.05 vol. %, less than or equal to 0.01 vol. %, or less) of the domain is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 μm³). In some non-limiting embodiments in which the solid support material comprises a metal, less than or equal to 1 vol. % (or less than or equal to 0.5 vol. %, less than or equal to 0.1 vol. %, less than or equal to 0.05 vol. %, less than or equal to 0.01 vol. %, or less) of the domain is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 m³).

In some non-limiting embodiments in which the solid support material comprises a metal, less than or equal to 20 vol. % (or less than or equal to 10 vol. %, less than or equal to 5 vol. %, less than or equal to 2 vol. %, less than or equal to 1 vol. %, less than or equal to 0.5 vol. %, less than or equal to 0.1 vol. %, less than or equal to 0.05 vol. %, less than or equal to 0.01 vol. %, or less) of the region within the outer boundaries of the solid support material is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 μm³). In some non-limiting embodiments in which the solid support material comprises a metal, less than or equal to 1 vol. % (or less than or equal to 0.5 vol. %, less than or equal to 0.1 vol. %, less than or equal to 0.05 vol. %, less than or equal to 0.01 vol. %, or less) of the region within the outer boundaries of the solid support material is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 m³).

In some non-limiting embodiments in which the solid support material comprises a ceramic, carbon material, a metal oxide, a metalloid oxide, a metal nitride, a metalloid nitride, a metal carbide, a metalloid carbide, a metal silicate, a metalloid silicate, a metal halide, and/or a metalloid halide, less than or equal to 20 vol. % (or less than or equal to 10 vol. %, less than or equal to 5 vol. %, less than or equal to 2 vol. %, less than or equal to 1 vol. %, less than or equal to 0.5 vol. %, less than or equal to 0.1 vol. %, less than or equal to 0.05 vol. %, less than or equal to 0.01 vol. %, or less) of the domain is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 μm³).

In some non-limiting embodiments in which the solid support material comprises a ceramic, carbon material, a metal oxide, a metalloid oxide, a metal nitride, a metalloid nitride, a metal carbide, a metalloid carbide, a metal silicate, a metalloid silicate, a metal halide, and/or a metalloid halide, less than or equal to 20 vol. % (or less than or equal to 10 vol. %, less than or equal to 5 vol. %, less than or equal to 2 vol. %, less than or equal to 1 vol. %, less than or equal to 0.5 vol. %, less than or equal to 0.1 vol. %, less than or equal to 0.05 vol. %, less than or equal to 0.01 vol. %, or less) of the region within the outer boundaries of the solid support material is occupied by voids having a volume of at least 10⁷ μm³ (or having a volume of at least 10⁶ m³, having a volume of at least 10⁵ μm³, having a volume of at least 10⁴ μm³, having a volume of at least 10³ m³, having a volume of at least 100 μm³, having a volume of at least 10 μm³, or having a volume of at least 1 m³).

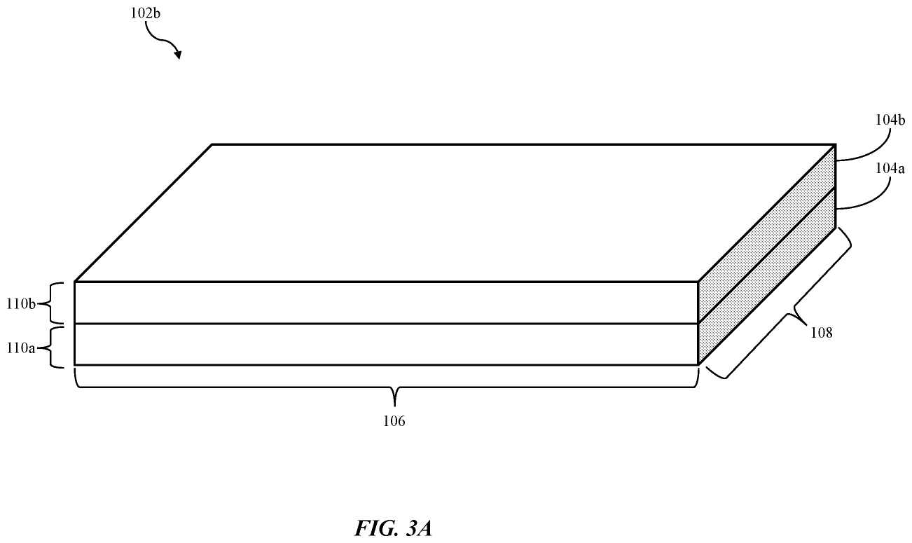

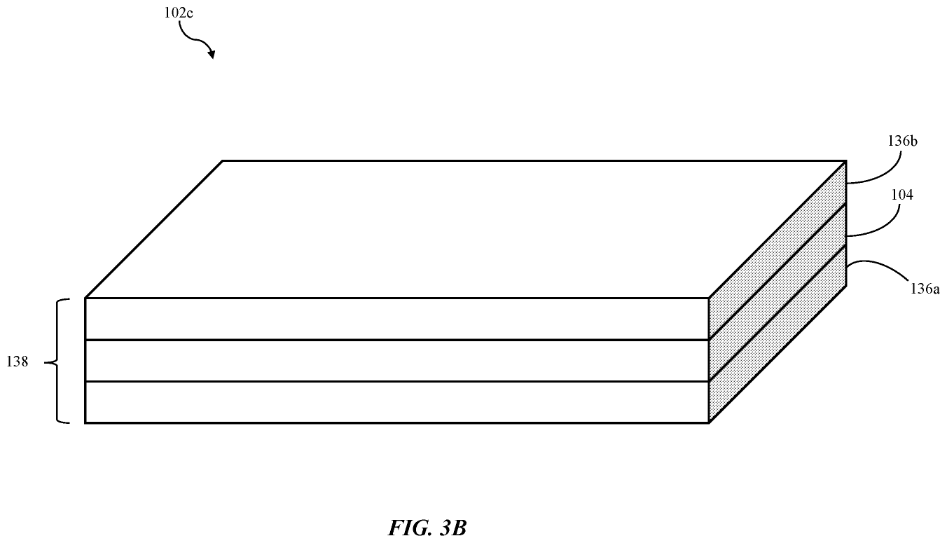

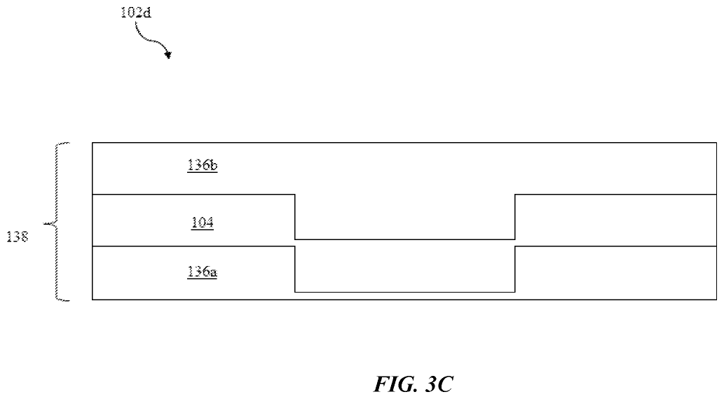

In some embodiments, the articles described herein comprise a first domain (e.g., any of the domains described above), and the article comprises at least a second domain at least partially in contact with the first domain. FIG. 3A shows, according to certain embodiments, article 102b comprising first domain 104a and second domain 104b. As shown in FIG. 3A, first domain 104a and second domain 104b are in contact with each other. In some embodiments, second domain 104b may be disposed on first domain 104a.

Second domain 104b may have any of a variety of suitable configurations, as described herein. In certain embodiments, first domain 104a and second domain 104b have the same or substantially the same configuration. In other embodiments, first domain 104a and second domain 104b are configured differently.

Each domain may comprise a third dimension. Referring to FIG. 3A, for example, domain 104a comprises third dimension 110a and domain 104b comprises third dimension 110b, each of which may have any of the lengths described above.

Although FIG. 3A shows article 102b comprising first domain 104a and second domain 104b, the articles described herein may comprise more than two domains (e.g., three domains, four domains, five domains, etc.), as the disclosure is not meant to be limiting in this regard.

According to certain embodiments, the article may comprise a domain comprising nanostructures and one or more additional layers. FIG. 3B shows, according to certain embodiments, a schematic diagram of an article comprising a stack of layers including a domain. As shown in FIG. 3B, article 102c comprises stack of layers 138 that includes domain 104, layer 136a (e.g., a bottom layer), and layer 136b (e.g., a top layer). In some embodiments, as shown in FIG. 3B, domain 104 may be disposed between layer 136a and layer 136b. In other embodiments, although not shown in the figures, the domain may be disposed at the bottom and/or top of the stack, as the disclosure is not meant to be limiting in this regard.

Although FIG. 3B shows article 102c comprising stack of layers 138 that includes domain 104 and two additional layers (e.g., bottom layer 136a and top layer 136b), an article as described herein may comprise a stack of layers that includes a domain and one additional layer, as the disclosure is not meant to be limiting in this regard. In some embodiments, an article described herein may comprise a stack of layers that includes a domain and more than two additional layers (three additional layers, four additional layers, five additional layers, etc.), as the disclosure is not meant to be limiting in this regard. In some embodiments, although not shown in the figures, the article may comprise more than one domain (e.g., two domains, three domains, etc.) and one or more additional layers (one additional layer, two additional layers, etc.).

In certain embodiments, the one or more additional layers of the article (e.g., layers 136a and 136b, as shown in FIG. 3B) may comprise a solid support material (e.g., the same solid support material that is present within the domain, a solid support material that is different than the solid support material that is present within the domain). In certain embodiments, the one or more additional layers of the article do not comprise the elongated nanostructures. In some embodiments, there is no discernable interface between the domain containing the nanostructures (e.g., domain 104 in FIG. 3B) and the one or more adjacent layers that do not include nanostructures (e.g., layers 136a and 136b in FIG. 3B).

According to certain embodiments, one or more domains and/or one or more additional layers may be patterned such that the one or more domains and/or the one or more additional layers interpenetrate each other. Configuring the device in this way advantageously provides reinforcement between layers. FIG. 3C shows, according to certain embodiments, a schematic side-view diagram of an article comprising a stack of layers including a domain. As shown in FIG. 3C, domain 104 may at least partially interpenetrate layer 136a, and layer 136b may at least partially interpenetrate domain 104. Other configurations are also possible. In some embodiments, for example, a device may comprise more than one domain (e.g., two domains, three domains, etc.), wherein at least a first domain interpenetrates a second domain.

According to certain embodiments, methods of making composite materials (and other methods) are also described. FIG. 4A shows, according to certain embodiments, a schematic diagram of a method of arranging a plurality of elongated nanostructures within a support material and/or a support material precursor. In some embodiments, the method comprises arranging a plurality of elongated nanostructures within a support material and/or a support material precursor to form an arrangement of elongated nanostructures and support material and/or support material precursor. Arranging comprises, in certain embodiments, growing the elongated nanostructures from a substrate. Referring to FIG. 4A, for example, step 302 comprises, in some embodiments, growing a forest of elongated nanostructures 114 from substrate 120. Substrate 120 may, in some embodiments, be or comprise a support material and/or a support material precursor. Substrate 120 may, in certain embodiments, comprise first dimension 106, second dimension 108, and third dimension 110. Methods of growing nanostructures are explained herein in greater detail.

According to some embodiments, the support material and/or support material precursor may be converted into the solid support material during the method of making the composite material. In certain embodiments, for example, the support material and/or support material may be hardened and/or heat treated to convert the support material and/or support material precursor into the solid support material, as explained herein in greater detail.

As used herein, a “forest” of elongated nanostructures corresponds to a plurality of elongated nanostructures arranged in side-by-side fashion with one another. In some embodiments, the nanostructures within the forest are in contact with at least one other nanostructure within the forest. In some embodiments, the forest of elongated nanostructures comprises at least 5, at least 10, at least 50, at least 100, at least 500, at least 1000, or at least 10,000 elongated nanostructures. In some such embodiments, the forest of elongated nanostructures may comprise at least 10⁶, at least 10⁷, at least 10⁸, at least 10⁹, at least 10¹⁰, at least 10¹¹, at least 10¹², or at least 10¹³ elongated nanostructures. Those of ordinary skill in the art are familiar with suitable methods for forming forests of elongated nanostructures. For example, in some embodiments, the forest of elongated nanostructures can be catalytically grown (e.g., using a growth catalyst deposited via a chemical vapor deposition process). In some embodiments, the as-grown forest can be used as is, while in other cases, the as-grown forest may be mechanically manipulated after growth and prior to subsequent processing steps described elsewhere herein (e.g., folding, shearing, compressing, buckling, etc.).

In some embodiments, the elongated nanostructures within the forest may be closely spaced. For example, the number average of the nearest neighbor distances of the elongated nanostructures within the forest may be less than or equal to 250 nm, less than or equal to 200 nm, less than or equal to 100 nm, less than or equal to 80 nm, less than or equal to 60 nm, less than or equal to 40 nm, less than or equal to 30 nm, less than or equal to 20 nm, less than or equal to 10 nm, less than or equal to 5 nm, or less. In certain embodiments, the number average of the nearest neighbor distances of the elongated nanostructures within the forest may be at least 1 nm, at least 5 nm, at least 10 nm, at least 20 nm, at least 30 nm, at least 40 nm, at least 60 nm, at least 80 nm, at least 100 nm, or at least 200 nm. Combinations of the above-referenced ranges are possible (e.g., at least 1 nm and less than or equal to 250 nm). Other ranges are also possible.

In some embodiments in which the nanostructures are grown on a substrate, the set of substantially aligned nanostructures may be oriented such that the longitudinal axes of the nanostructures are substantially non-parallel to the surface of the growth substrate, for example, as shown in FIG. 4A. In some cases, the longitudinal axes of the nanostructures are oriented in a substantially perpendicular direction with respect to the surface of the growth substrate.

Systems and methods for growing elongated nanostructures (including forests of elongated nanostructures) are described, for example, in International Patent Application Serial No. PCT/US2007/011914, filed May 18, 2007, entitled “Continuous Process for the Production of Nanostructures Including Nanotubes,” published as WO 2007/136755 on Nov. 29, 2007; U.S. patent application Ser. No. 12/227,516, filed Nov. 19, 2008, entitled “Continuous Process for the Production of Nanostructures Including Nanotubes,” published as US 2009/0311166 on Dec. 17, 2009; International Patent Application Serial No. PCT/US07/11913, filed May 18, 2007, entitled “Nanostructure-reinforced Composite Articles and Methods,” published as WO 2008/054541 on May 8, 2008; International Patent Application Serial No. PCT/US2008/009996, filed Aug. 22, 2008, entitled “Nanostructure-reinforced Composite Articles and Methods,” published as WO 2009/029218 on Mar. 5, 2009; U.S. patent application Ser. No. 11/895,621, filed Aug. 24, 2007, entitled “Nanostructure-Reinforced Composite Articles and Methods,” published as US 2008/0075954 on Mar. 27, 2008; and U.S. patent application Ser. No. 12/618,203, filed Nov. 13, 2009, entitled “Controlled-orientation Films and Nanocomposites Including Nanotubes or Other Nanostructures”, published as US 2010/0196695, on Aug. 5, 2010; each of which is incorporated herein by reference in its entirety for all purposes.

In some embodiments, arranging comprises rearranging the elongated nanostructures from a first position that is non-parallel to the substrate to a second position that is substantially parallel to the substrate. In certain embodiments, alignment of the nanostructures (e.g., with each other and/or to a common vector, and to any degree referenced above) can be established and/or maintained during the process of arranging the nanostructures in a direction substantially parallel to the substrate. As noted above, maintaining alignment of the nanostructures can allow for support material and/or a support material precursor to flow through and spread between the elongated nanostructures via capillary action, which can result in a high volume of elongated nanostructures, low volume of voids, and large scale in at least two dimensions in the final composite. Referring again to FIG. 4A, for example, step 304 comprises, in certain embodiments, rearranging elongated nanostructures 114 from a first position that is non-parallel to substrate 120 (e.g., as shown in step 302) to a second position that is substantially parallel to substrate 120. In some embodiments, rearranging comprises knocking over elongated nanostructures 114 using mechanical tool 118. Examples of mechanical tools include, but are not limited to, a roller, a doctor blade, and the like.

FIG. 4B shows, according to certain embodiments, a cross-sectional schematic diagram of a method of applying pressure to an arrangement of elongated nanostructures and substrate. In some embodiments, the method comprises applying pressure to the arrangement of elongated nanostructures and substrate to densify the nanostructures. Referring to FIG. 4B, for example, an arrangement of elongated nanostructures and substrate may be provided, for example, from step 304 in FIG. 4A.

In certain embodiments, step 305 comprises applying pressure to the arrangement of elongated nanostructures 114 and substrate 130 to densify elongated nanostructures 114, as shown, for example, in step 306. Pressure may be applied in any of a variety of suitable directions 134. In certain embodiments, the densification process may facilitate the removal of one or more voids present in the substrate from the manufacturing process.

According to certain embodiments, at least one dimension of substrate 120 may change as a result of the densification process. Referring, for example, to FIG. 4B, at least one of first dimension 106′, second dimension 108′ (not shown in FIG. 4B), and/or third dimension 110′ of substrate 120′ shown in step 305 may be different from first dimension 106″, second dimension 108′ (not shown in FIG. 4B), and/or third dimension 110″ of substrate 120″ shown in step 306. In certain non-limiting embodiments, for example, third dimension 110″ may be shorter than third dimension 110′ after the densification process.

In some embodiments, arranging comprises adding the support material and/or the support material precursor to the elongated nanostructures. In certain embodiments, an arrangement of elongated nanostructures and substrate may be provided, for example, from step 304 as shown in FIG. 4A (e.g., without densification) or step 306 as shown in FIG. 4B (e.g., with densification). For example, in FIG. 4A, step 307 comprises, in some embodiments, adding support material and/or support material precursor 122, thereby providing, as shown in step 308, a plurality of elongated nanostructures 114 arranged within support material and/or support material precursor 122. Support material and/or support material precursor 122 may be added to the plurality of elongated nanostructures 114 by any of a variety of suitable means, including, but not limited to, atomic layer deposition (ALD), chemical vapor deposition (CVD), and/or chemical vapor infiltration (CVI). In some embodiments, support material and/or support material precursor may be added to the plurality of elongated nanostructures via capillary action.

Although not shown in the figures, the support material and/or support material precursor may be added to the elongated nanostructures, in some embodiments, prior to rearranging the elongated nanostructures from a first position that is non-parallel to the substrate to a second position that is substantially parallel to the substrate. In certain embodiments, for example, step 307 in FIG. 4A may precede step 304.

According to some embodiments, the support material and/or support material precursor may comprise, in some embodiments, a material that is capable of being hardened (e.g., by curing), as explained in further detail below. In some embodiments, the support material and/or support material precursor may be in particulate form (e.g., nanoparticles). In certain embodiments, the support material and/or support material precursor may comprise a solvent.

FIG. 4C shows, according to certain embodiments, a cross-sectional schematic diagram of an alternative method of arranging a plurality of elongated nanostructures within a support material and/or a support material precursor. According to some embodiments, arranging comprises suspending the elongated nanostructures and the support material and/or the support material precursor within a medium. The medium may, in some embodiments, be a fluid (e.g., a liquid, a mixture of liquid and gas), a sol (e.g., a suspension of a colloidal solid in a liquid) and/or a gel. Referring to FIG. 4C, for example, step 312 comprises, in some embodiments, suspending elongated nanostructures 114 and support material and/or support material precursor 122 within medium 132. According to some embodiments and as shown in step 312 of FIG. 4C, elongated nanostructures 114 may be substantially aligned in medium 132.

In certain embodiments, arranging comprises removing at least a portion of the medium (e.g., fluid) to leave behind a deposit comprising a greater volume fraction of the elongated nanostructures and the support material and/or the support material precursor relative to the original volume fractions of these materials within the medium (e.g., fluid). Referring again to FIG. 4C, for example, step 314 comprises removing at least a portion of medium 132 (e.g., by vacuum, by application of heat, by evaporation, by using a mechanical tool such as a film and/or roller to mechanically remove at least a portion of the medium, etc.) to leave behind a deposit comprising a greater volume fraction of elongated nanostructures 114 and support material and/or support material precursor 122 relative to the original volume fractions of these materials within medium 132. Step 316 shows, according to some embodiments, a plurality of elongated nanostructures 114 arranged within support material and/or support material precursor 122.

FIG. 4D shows, according to certain embodiments, a cross-sectional schematic diagram of a method of applying pressure to an arrangement of elongated nanostructures and support material and/or support material precursor. In some embodiments, the method comprises applying pressure to the arrangement to densify the nanostructures. Referring to FIG. 4D, for example, an arrangement of elongated nanostructures and support material and/or support material precursor may be provided, for example, from step 308 as shown in FIG. 4A or step 316 as shown in FIG. 4C.

In certain embodiments, step 322 comprises applying pressure to the arrangement of elongated nanostructures 114 and support material and/or support material precursor 122 to densify elongated nanostructures 114, as shown, for example, in step 324. Pressure may be applied in any of a variety of suitable directions 134. In some embodiments, pressure may be applied by hot pressing the arrangement of elongated nanostructures 114 and support material and/or support material precursor 122. In certain embodiments, the densification process may facilitate the removal of one or more voids and/or fluids (e.g., liquid solvents) present in the support material and/or the support material precursor from the manufacturing process.

According to certain embodiments, at least one dimension of domain 104 may change as a result of the densification process. Referring, for example, to FIG. 4D, at least one of first dimension 106′, second dimension 108′ (not shown in FIG. 4D), and/or third dimension 110′ of domain 104′ shown in step 322 may be different from first dimension 106″, second dimension 108″ (not shown in FIG. 4D), and/or third dimension 110″ of domain 104″ shown in step 324. In certain non-limiting embodiments, for example, third dimension 110″ may be shorter than third dimension 110′ after the densification process.

FIG. 4E shows, according to certain embodiments, a cross-sectional schematic diagram of a method of hardening the support material and/or support material precursor. In certain embodiments, the method comprises hardening the support material and/or the support material precursor to form a domain of elongated nanostructures within the solid support material. Referring to FIG. 4E, for example, step 332 comprises hardening the support material and/or the support material precursor to form domain 104 of elongated nanostructures 114 within solid support material 112. In some embodiments, for example, hardening may convert the support material and/or the support material precursor into the solid support material.

The support material and/or the support material precursor may be hardened in any of a variety of suitable ways. According to some embodiments, for example, hardening the support material and/or the support material precursor comprises sintering the support material and/or the support material precursor. In other embodiments, hardening the support material and/or the support material precursor comprises cooling a liquid (e.g., a melted) support material and/or a liquid (e.g., a melted) support material precursor below its melting temperature. In yet other embodiments, hardening the support material and/or the support material precursor comprises curing the support material and/or the support material precursor. Curing may be performed, in some embodiments, using microwave and/or ultraviolet (UV) radiation.

According to some embodiments, the support material and/or the support material precursor may be converted into the solid support material via reduction and/or decomposition (e.g., by heat treating) of the support material and/or the support material precursor. In certain embodiments in which the solid support material comprises a metal, for example, the support material and/or the support material precursor may comprise a metal salt that is reduced to the metal, for example, via heat treating of the metal salt. In some embodiments wherein the solid support material comprises a metal oxide, a metalloid oxide, a metal nitride, a metalloid nitride, a metal halide, and/or a metalloid halide, the support material and/or the support material precursor may comprise a metal(loid) salt that decomposes into the metal oxide, the metalloid oxide, the metal nitride, the metalloid nitride, the metal halide, and/or the metalloid halide, for example, via heat treating of the metal(loid) salt. Converting the support material and/or the support material precursor into the solid support material (e.g., via heat treating) may, in some embodiments, occur after arranging the plurality of elongated nanostructures within the support material and/or the support material precursor. In other embodiments, converting the support material and/or the support material precursor into the solid support material may occur after applying pressure to the arrangement of elongated nanostructures and support material and/or support material precursor.

According to certain embodiments, prior to hardening, multiple articles comprising the plurality of elongated nanostructures distributed within the support material and/or support material may be stacked on top of one another. Each of the articles comprising the plurality of elongated nanostructures distributed within the support material and/or support material precursor may be a green article, as would be understood by a person of ordinary skill in the art. The multiple green articled stacked on top of one another may then be hardened, as described herein.

The presence of elongated nanostructures within composite materials may impart desirable properties. For example, in some cases a composite material may exhibit a higher mechanical strength and/or toughness when compared to an essentially identical material lacking elongated nanostructures under essentially identical conditions. In some cases, a composite material may exhibit a higher thermal and/or electrical conductivity when compared to an essentially identical composite material lacking the elongated nanostructures, under essentially identical conditions. In some cases, the mechanical, thermal, electrical conductivity, and/or other properties (e.g., electromagnetic properties, specific heat, etc.) may be anisotropic.

According to certain embodiments, the article and/or domain as described herein may be used as a feedstock for manufacturing. In some embodiments, for example, a feedstock may be provided, wherein the feedstock is or comprises the domain (e.g., having any of the high nanostructure loadings and/or the low void volumes described herein). The feedstock may be used for additive manufacturing, in some embodiments. In certain embodiments, for example, the additive manufacturing comprises rearranging at least of portion of the feedstock from a first shape to a second shape that is different from the first shape. In some embodiments, the rearranging may comprise forming one or more particles and/or fluids (e.g., liquids and/or suspensions) from the feedstock. The one or more particles and/or fluids may, in certain embodiments, be formed into the second shape, for example, by depositing the particles and/or fluids in a pattern and subsequently forming a solid from them.

Suitable additive manufacturing processes include, but are not limited to, vat polymerization, material jetting, binder jetting, material extrusion, sheet lamination, powder bed fusion, fused filament fabrication, and/or directed energy deposition. In some embodiments, for example, vat polymerization comprises forming at least a portion of the domain into a liquid photopolymer in a vat and selectively curing the liquid photopolymer by light-activated polymerization. In certain embodiments, material jetting comprising forming droplets from at least a portion of the domain and selectively depositing the droplets. In some embodiments, binder jetting comprises forming a powder material from at least a portion of the domain and joining the powder material by selectively depositing a liquid bonding agent. In certain embodiments, material extrusion comprises selectively dispensing at least a portion of the domain through a nozzle or orifice. In some embodiments, sheet lamination comprises forming sheets of at least a portion of the domain and bonding the sheets. In certain embodiments, powder bed fusion comprises forming a powder bed from at least a portion of the domain and using thermal energy to selectively fuse regions of the powder bed. In some embodiments, directed energy deposition comprises melting at least a portion of the domain and using focused thermal energy to fuse the melted material. See, for example, ASTM F42 on Additive Manufacturing Technologies. Feedstock for additive manufacturing (AM) benefits from micro- and nano-fiber/particulate reinforcement, much like traditional composites. Reinforced feedstocks for additive manufacturing have been primarily investigated for carbon-based nanostructures such as CNTs and graphene in polymer feedstock filament for fused filament fabrication (FFF). Certain embodiments described herein in which the article includes a high volume fraction of elongated nanostructures in a domain with low voids, the article can be used as a feedstock for additive manufacturing by, for example, slicing or slitting the feedstock (e.g., sheets of the feedstock) to produce a filament feedstock (e.g., for FFF) that has nanofiber reinforcement that is at least 10 times higher than is believed to be currently possible for any polymer, thermosets or thermoplastics. After slicing and/or slitting the feedstock, post-processing can be used, in some embodiments, to form the fiber into a round or otherwise useful cross-section (e.g., square or otherwise rectangular, elliptical, etc.). The high loadings of elongated nanostructures can also make feedstock for other AM processes, such as sheet lamination molding, selective laser sintering (SLS), and others.

The following examples are intended to illustrate certain embodiments of the present invention, but do not exemplify the full scope of the invention.

### Example 1

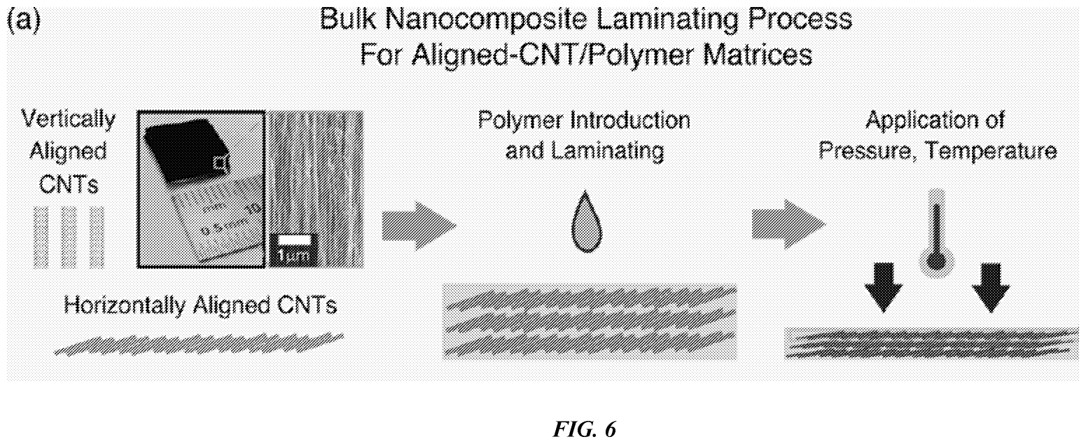

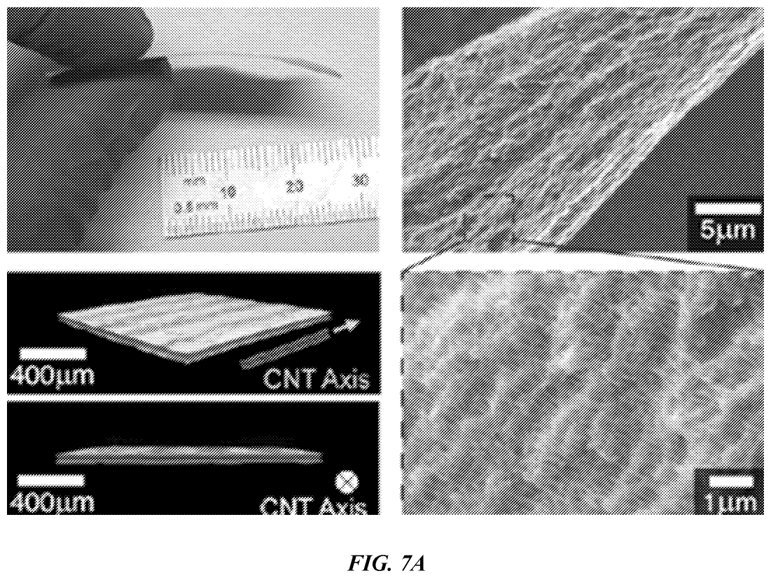

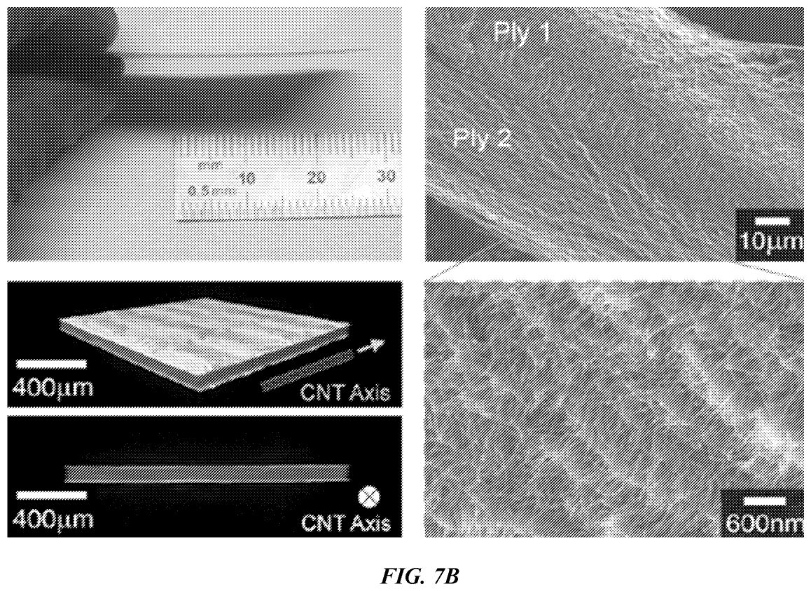

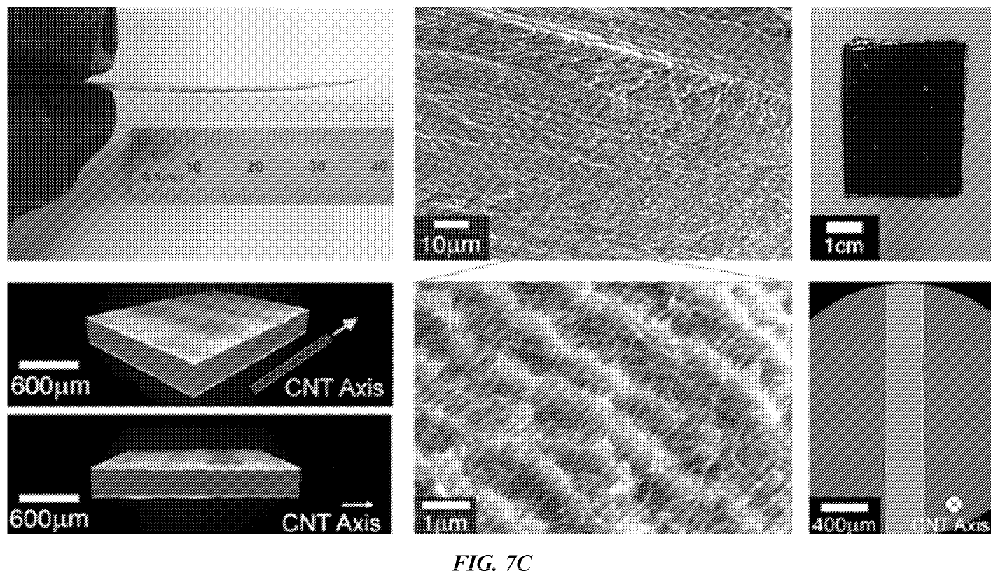

The following example describes a bulk nanocomposite laminating (BNL) process for the scaled production of tough and strong long aligned-carbon nanotube-reinforced-polymer matrix nanocomposites (A-CNT-reinforced PNCs). The BNL process may be used to form both individual composite layers and laminates. The BNL process, as shown in FIG. 6, is demonstrated at the 5 centimeter-scale to create single plies and then multi-layer unidirectional laminates with two and eight plies of the high-T_{g} aerospace-grade bismaleimide (BMI) resin infused into densely packed horizontally aligned CNTs. Vertically aligned CNT arrays were synthesized, knocked down to induce horizontal alignment, laminated and infused with a polymer, and subjected to additional pressure and temperature to form the final ply and laminate composites, achieving ˜13 vol. % aligned CNTs in a BMI matrix, as confirmed by thermogravimetric analysis (TGA). Optical micrographs, SEM images, and X-ray micro-CT images show successful BNL composite fabrication in this scaling demonstration, where full polymer infusion, no microvoids, uniform density, maintained CNT alignment and dispersion, and thorough CNT-BMI wetting are achieved for a 1-ply lamina (FIG. 7A), 2-ply laminate (FIG. 7B), and 8-ply laminate (FIG. 7C). The laminates are void-free at the micron scale, fully infused with BMI, and contain high volume fractions of A-CNTs, demonstrating a new platform for creating tough and strong long nanofiber-reinforced bulk composites towards extreme volume fractions and nanofiber lengths.

### Example 2

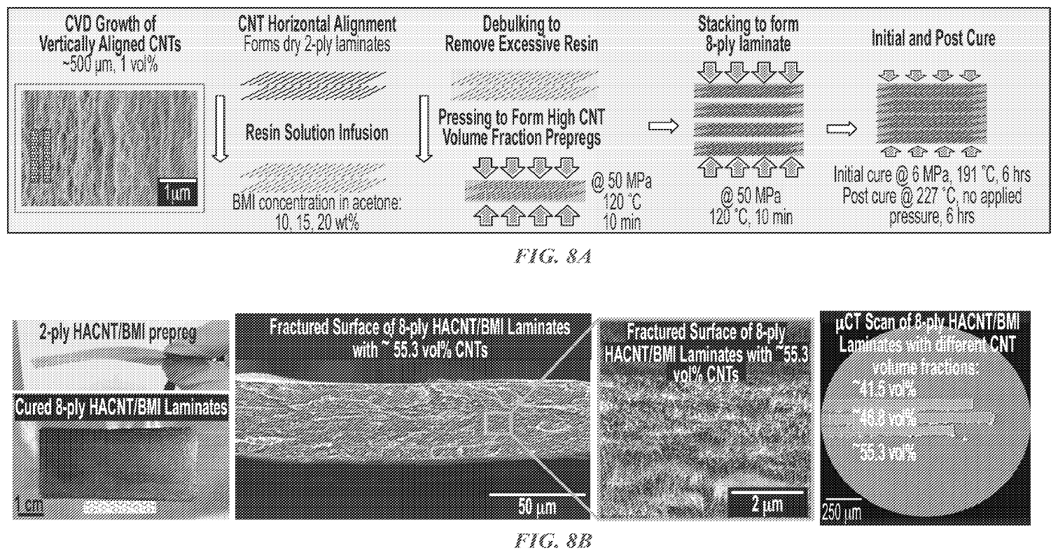

The following example describes a BNL process for the production of high volume fraction A-CNT-reinforced PNCs. The BNL process is shown in FIG. 8A. Briefly, vertically aligned CNTs were grown by chemical vapor deposition (CVD). The vertically aligned CNTs were rearranged by knockdown, forming horizontally aligned CNTs. Two 1-ply lamina were layered, followed by resin solution infusion. The resin solutions contained polybismaleimide (BMI) in acetone at various concentrations (10 wt. %, 15 wt. %, and 20 wt. %). Excess resin was removed from the 2-ply laminate, followed by pressing at 50 MPa at 120° C. for 10 minutes to form a high CNT volume fraction 2-ply laminate. Four 2-ply laminates were stacked, followed by pressing at 50 MPa at 120° C. for 10 minutes to form an 8-ply laminate. The 8-ply laminate was initially cured at 6 MPa, 191° C. for 6 hours and then cured at 227° C. for 6 hours. The CNT volume fraction varied from 41.5 vol. % to 55.3 vol. % depending on the concentration of BMI in the resin solution. No voids were observed in the composite as measured by X-ray computed tomography with the resolution set to detect voids having a volume of 64 μm³. See FIG. 8B.

### Example 3

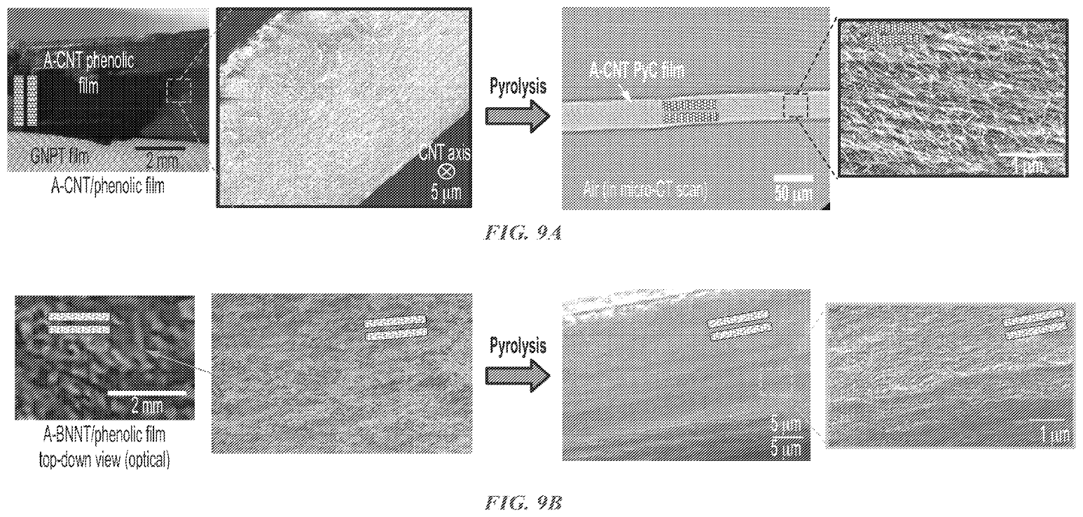

The following example describes a BNL process for the production of aligned-carbon nanotube-reinforced-pyrolytic carbon matrix nanocomposites. Briefly, vertically aligned CNTs were grown by chemical vapor deposition (CVD). The vertically aligned CNTs were rearranged by knockdown, forming horizontally aligned CNTs. The 1-ply lamina was infused with a resin solution containing 65 wt. % phenol in acetone, and then pyrolyzed at 1000° C. for 1 hour in N₂. No voids were observed in the composite as measured by X-ray computed tomography with the resolution set to detect voids having a volume of 64 μm³. See FIG. 9A.

### Example 4

The following example describes a BNL process for the production of aligned-BNNT-reinforced-pyrolytic carbon matrix nanocomposites. Briefly, vertically aligned BNNTs were grown by chemical vapor deposition (CVD). The vertically aligned BNNTs were rearranged by knockdown, forming horizontally aligned BNNTs. The 1-ply lamina was infused with a resin solution containing 65 wt. % phenol in acetone, and then pyrolyzed at 1000° C. for 1 hour in N₂. No voids were observed in the composite as measured by X-ray computed tomography with the resolution set to detect voids having a volume of 64 μm³. See FIG. 9B.

### Example 5

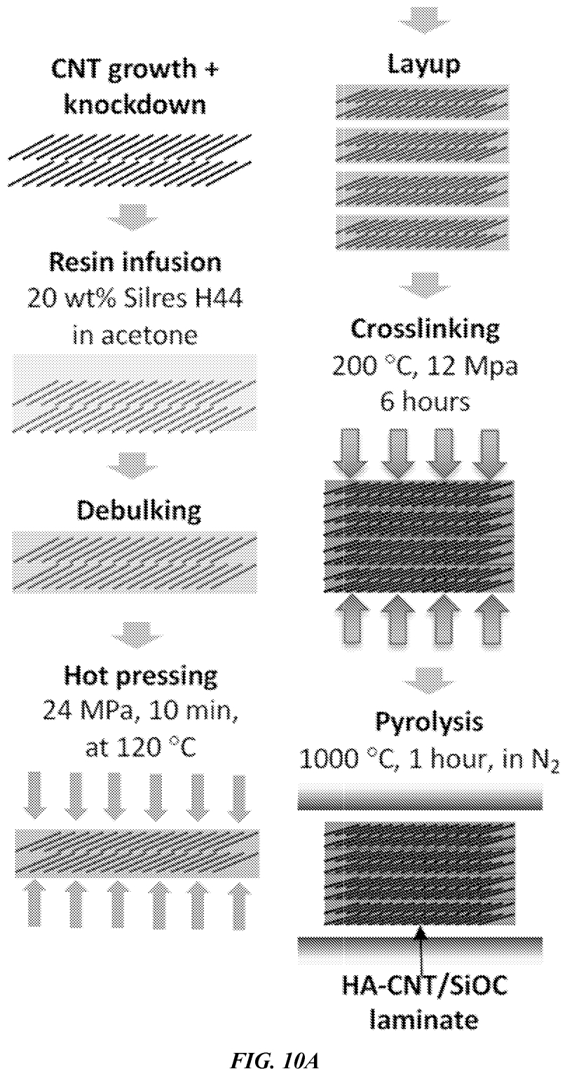

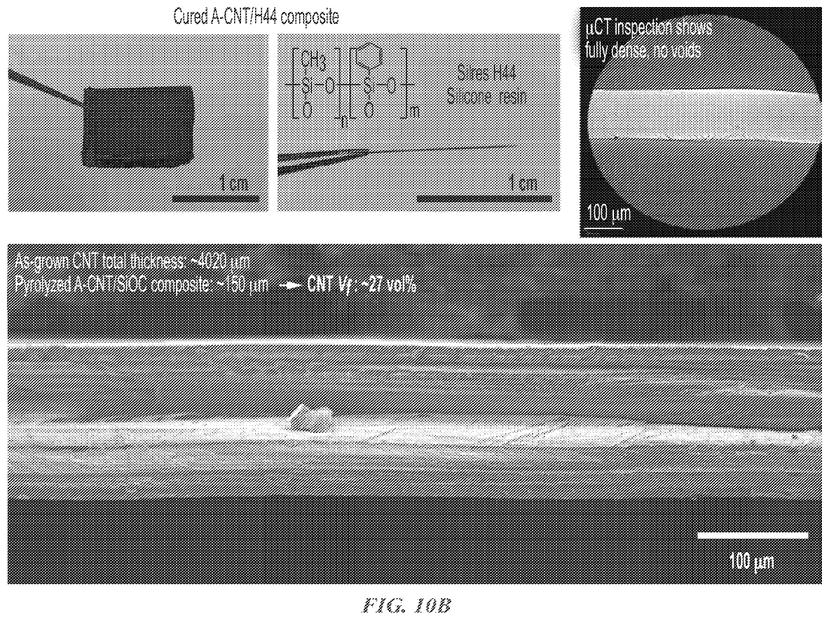

The following example describes a BNL process for the production of aligned-carbon nanotube-reinforced-silicon oxycarbide matrix nanocomposites. The BNL process is shown in FIG. 10A. Briefly, vertically aligned CNTs were grown by chemical vapor deposition (CVD). The vertically aligned CNTs were rearranged by knockdown, forming horizontally aligned CNTs. Two 1-ply lamina were layered, followed by resin solution infusion. The resin solution contained 20 wt. % Silres H44 and catalyst (triethanolamine) in acetone. Excess resin was removed from the 2-ply laminate by spin coating at 4000 rpm for 30 seconds. The 2-ply laminate was subjected to hot pressing at 24 MPa at 120° C. for 10 minutes. Four 2-ply laminates were stacked, followed by pressing at 24 MPa at 120° C. for 10 minutes to form an 8-ply laminate. The 8-ply laminate was crosslinked at 12 MPa at 200° C. for 6 hours and pyrolyzed at 1000° C. for 1 hour in N₂. The CNTs in the resulting nanocomposite occupied a volume fraction of 27 vol. %. No voids were observed in the composite as measured by X-ray computed tomography with the resolution set to detect voids having a volume of 64 μm³. See FIGS. 10A-10B.

### Example 6

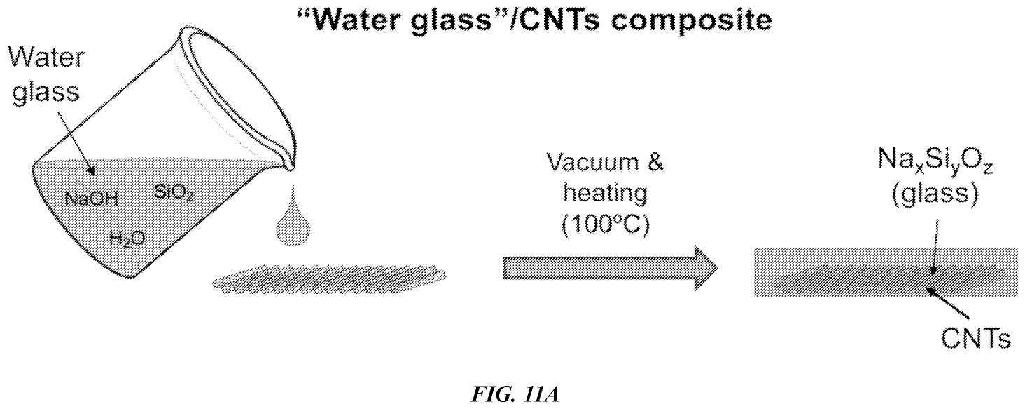

The following example describes a BNL process for the production of aligned-carbon nanotube-reinforced-sodium silicate matrix nanocomposites. The BNL process is shown in FIG. 11A. Briefly, deionized (DI) water was mixed with 0.45 g/ml of NaOH for a few minutes under constant stirring. Silica powder was slowly added to the NaOH solution under constant agitation at a temperature of −80° C. until a total concentration of 0.25 g/ml was reached, providing a sodium silicate (e.g., water glass) solution. The water glass solution was poured on top of CNTs on a Guaranteed Nonporous Teflon (GNPT) film and the composite was dried under vacuum (˜10 mbar) overnight at 100° C. The composite was peeled off from the GNPT film. No voids were observed in the composite as measured by X-ray computed tomography with the resolution set to detect voids having a volume of 64 μm³. See FIG. 111B.

### Example 7

The following example describes a BNL process for the production of vertically aligned-carbon nanotube-reinforced-sodium chloride matrix nanocomposites. Briefly, a forest of vertically aligned CNTs were placed inside a metal mold. A Teflon mat was applied on top of the mold to limit the CNT forest's movement during vacuum infusion. A saturated sodium chloride solution was prepared. Either the CNT forest and the metal mold were immersed in the saturated sodium chloride solution, or the sodium chloride solution was applied on top on the CNT forest. Infusion was performed in an oven under vacuum for 30 minutes. After infusion, the infused CNT forest was dried at 80° C. in vacuum for 1 hour. No voids were observed in the composite as measured by X-ray computed tomography with the resolution set to detect voids having a volume of 64 μm³.

### Example 8

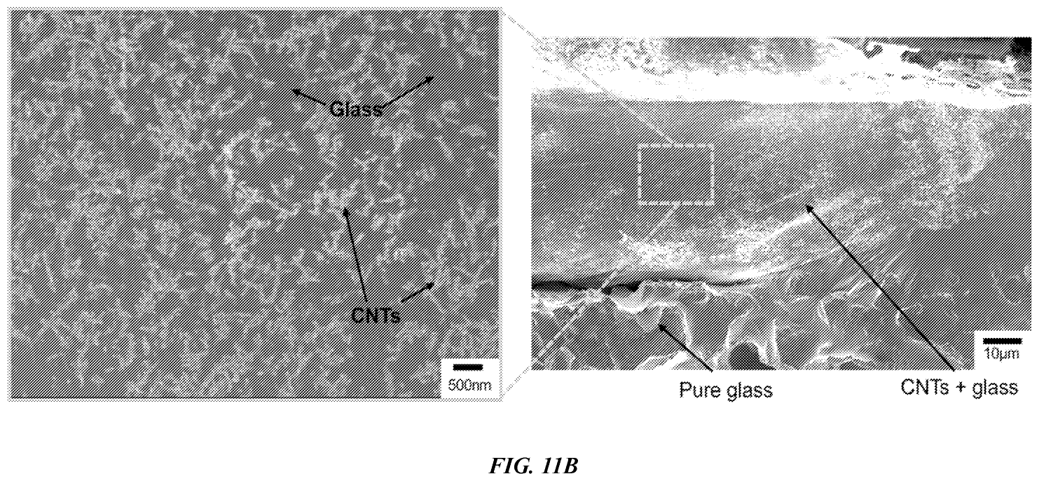

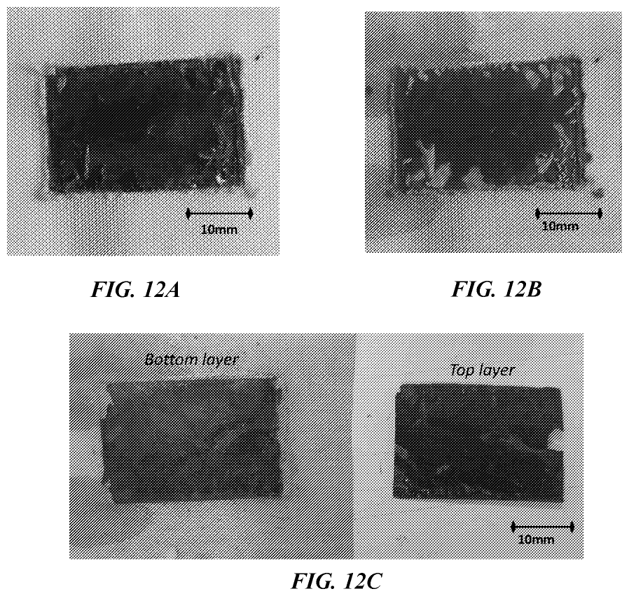

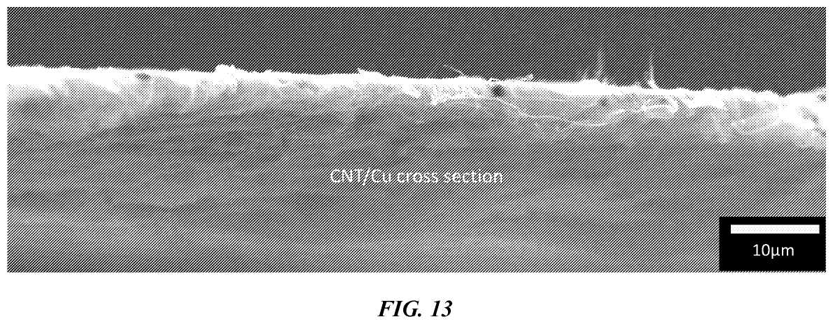

The following example describes a BNL process for the production of aligned-carbon nanotube-reinforced-copper matrix nanocomposites. The BNL process is shown in FIGS. 12A-12C. Briefly, DI water was mixed with CuSO₄ for a few minutes under constant stirring at a concentration of 10 mM. This solution was drop casted on top of 2 layers of horizontally-aligned CNTs, formed by knocking down vertically-aligned CNTs, on a GNPT film. Then the composite was dried under vacuum for a few hours. The drop cast and vacuum steps were repeated 10 times, and the final result is shown in FIG. 12A. The sample was then heat treated under argon and hydrogen for 1 hour at 200° C. to reduce the copper acetate to metallic copper, as shown in FIG. 12B. The full penetration of copper in both layers was observed by splitting the two CNT layers (see FIG. 12C). FIG. 13 shows a cross-sectional SEM image of the CNT/Cu nanocomposite.

### Example 9

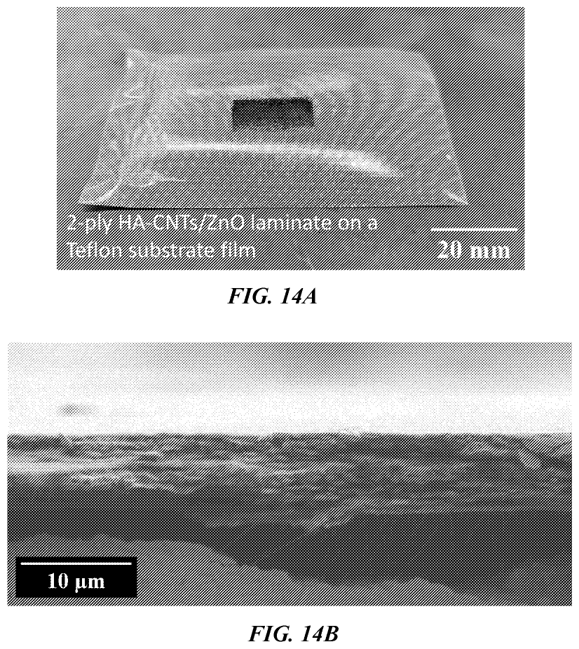

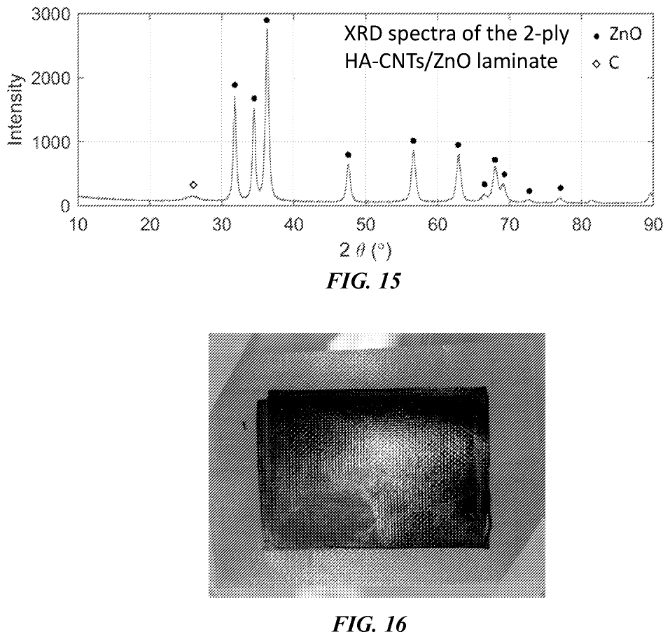

The following example describes a BNL process for the production of aligned-carbon nanotube-reinforced-zinc oxide matrix nanocomposites. Briefly, ethanol was mixed with 0.4 g/ml of zinc nitrate hexahydrate for a few minutes under constant stirring, providing a zinc nitrate hexahydrate solution. The zinc nitrate hexahydrate ethanol solution was drop casted on top of a 2-ply horizontally aligned CNT laminate (created via knockdown) for solution infusion. The excess solution was removed using a pipette and mechanically squeezed out by rolling using a GNPT film, followed by drying in a vacuum oven (˜10 mbar) at 60° C. for 1 hour to remove ethanol. The dried 2-ply laminate was subjected to heat treatment in air at 300° C. in a tube furnace during which zinc nitrate hexahydrate dehydrated and decomposed to form zinc oxide. The 2-ply laminate was further densified via a cold sintering process: an aqueous solution of acetic acid with 1 M concentration was prepared by mixing DI water with 0.06 g/ml of acetic acid, then the 2-ply laminate was wetted with the 1 M acetic acid solution and subjected to hot pressing at 130° C. with 50 MPa pressure for 1 hour. The hot-pressed composite retained its original geometry (see FIG. 14A). SEM inspection of a fractured cross-section of the composite showed the fully dense microstructure of the fabricated CNT-ZnO laminate (see FIG. 14B). The formation of ZnO was confirmed using X-ray diffraction (see FIG. 15).

### Example 10

The following example describes a BNL process for the production of aligned-carbon nanotube-reinforced-thermoplastic PNCs. Vertically aligned CNTs were grown by chemical vapor deposition (CVD). The vertically aligned CNTs were rearranged by knockdown, forming horizontally aligned CNTs. Two 1-ply lamina were layered, followed by resin solution infusion. The resin solution contained poly(methyl methacrylate) (PMMA) in anisole at a concentration of 9 wt. %. Excess resin was removed from the 2-ply laminate by spin coating, followed by evaporation of excess solvent with vacuum at 80° C. and hot pressing at 50 MPa at 180° C. for 10 minutes to form a 3 cm×4 cm 2-ply thermoplastic BNL laminate with high CNT volume fraction (see FIG. 16).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An article, comprising:
a domain, comprising:
a solid support material; and
a plurality of elongated nanostructures distributed within the solid support material;
wherein:
within the domain, the elongated nanostructures occupy a volume fraction of at least 5 vol. %;
less than or equal to 20 vol. % of the domain is occupied by voids having a volume of at least 10⁷ μm³;
the domain comprises a first dimension having a length of at least 1 centimeter; and
the domain comprises a second dimension that is perpendicular to the first dimension, the second dimension having a length of at least 1 centimeter.

2. The article of claim 1, wherein the solid support material comprises a polymer.

3. The article of claim 1, wherein the solid support material comprises a ceramic, a carbon material, a metal, a metal oxide, a metalloid oxide, a metal nitride, a metalloid nitride, a metal carbide, a metalloid carbide, a metal silicate, a metalloid silicate, a metal halide, and/or a metalloid halide.

4. The article of claim 1, wherein the solid support material comprises a ceramic.

5. The article of claim 1, wherein the solid support material comprises a metal.

6. The article of claim 1, wherein the elongated nanostructures comprise nanotubes, nanofibers, or nanowires.

7. The article of claim 1, wherein the domain comprises a third dimension that is perpendicular to the first dimension and the second dimension, the third dimension having a length of at least 1 micrometer.

8. The article of claim 1, wherein at least a portion of the elongated nanostructures within the plurality of nanostructures are arranged in a non-overlapping fashion.

9. The article of claim 1, wherein a first portion of the elongated nanostructures within the plurality of nanostructures are arranged such that the first portion of the elongated nanostructures at least partially overlap a second portion of the elongated nanostructures within the plurality of nanostructures.

10. The article of claim 1, wherein, within the domain, the elongated nanostructures occupy a volume fraction of less than or equal to 78 vol. %.

11. The article of claim 1, wherein the first dimension of the domain is substantially parallel to longitudinal axes of the elongated nanostructures.

12. The article of claim 1, wherein longitudinal axes of the elongated nanostructures are substantially aligned with each other.

13. The article of claim 1, wherein the domain is a first domain and the article comprises at least a second domain at least partially in contact with the first domain.

14. The article of claim 1, wherein less than or equal to 1 vol. % of the domain is occupied by voids having a volume of at least 10⁷ μm³.

15. A method, comprising:
arranging a plurality of elongated nanostructures within a support material and/or a support material precursor to form an arrangement of elongated nanostructures and support material and/or support material precursor;
applying pressure to the arrangement to densify the nanostructures; and
hardening the support material and/or the support material precursor to form a domain of elongated nanostructures within solid support material;
wherein:
within the domain, the elongated nanostructures occupy a volume fraction of at least 5 vol %;
less than or equal to 20 vol. % of the domain is occupied by voids having a volume of at least 10⁷ μm³;
the domain comprises a first dimension having a length of at least 1 centimeter; and
the domain comprises a second dimension that is perpendicular to the first dimension, the second dimension having a length of at least 1 centimeter.

16. The method of claim 15, wherein the arranging comprises:
growing the elongated nanostructures from a substrate;
rearranging the elongated nanostructures from a first position that is non-parallel to the substrate to a second position that is substantially parallel to the substrate; and
adding the support material and/or the support material precursor to the elongated nanostructures.

17. The method of claim 16, wherein the rearranging comprises knocking over the nanostructures using a mechanical tool.

18. The method of claim 17, wherein the mechanical tool comprises a roller.

19. The method of claim 15, wherein the arranging comprises:
suspending the elongated nanostructures and the support material and/or the support material precursor within a liquid; and
removing at least a portion of the liquid to leave behind a deposit comprising a greater volume fraction of the elongated nanostructures and the support material and/or the support material precursor relative to the original volume fractions of these materials within the liquid.

20. The method of claim 15, wherein hardening the support material and/or the support material precursor comprises sintering the support material and/or the support material precursor.

21-63. (canceled)
